(19) United States
(12) Patent Application Publication
(10) Pub. No.: US 2009/0223422 A1
(43) Pub. Date: Sep. 10, 2009

(54) PALLETS RAILS AND METHODS FOR MAKING SAME

(75) Inventors: David Wesley Monteith, Charlotte, NC (US); Jean Francois Ruffet, Gastonia, NC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: CONITEX-SONOCO, LLC, Gastonia, NC (US)

(21) Appl. No.: 12/468,172

(22) Filed: May 19, 2009

Related U.S. Application Data
(63) Continuation-in-part of application No. 11/625,543, filed on Jan. 22, 2007.
(60) Provisional application No. 60/747,626, filed on May 18, 2006.

(51) Int. Cl. B65D 19/40; B65D 19/38; B31C 99/00

(52) U.S. Cl. 108/51.3; 493/297

(57) ABSTRACT

A pallet rail includes an elongate support box and a plurality of separately formed reinforcing tubes. The support box is formed from a paper blank that is folded along parallel fold lines. The reinforcing tubes are positioned within the support box to reinforce the box. Two side walls have arcuate corners to define two opposing longitudinal ends of the support box having curved lower profiles. Another pallet rail includes an elongate support box, an adjacent end wall, and a plurality of separately-formed reinforcing tubes.

### CROSS-REFERENCE TO RELATED APPLICATIONS

This application is a Continuation-in-Part (CIP) application of, and claims the benefit of priority of U.S. patent application Ser. No. 11/625,543, previously filed on Jan. 22, 2007, and entitled “Pallet and Methods for Making Same.” Both this CIP application and the previously filed 11/625,543 application claim the benefit of priority of U.S. Provisional Application No. 60/747,626, filed May 18, 2006. The contents of each of the 11/625,543 and the 60/747,626 applications are hereby incorporated herein by this reference.

### TECHNICAL FIELD AND BACKGROUND OF THE INVENTION

The invention relates generally to pallets for supporting objects and methods for making same, and more particularly to a pallet rail having arcuate corners to minimize jamming of the pallet rail as it is moved and a pallet rail having an upwardly projecting end wall for aligning the pallet rail along the side of a palletized load.

Pallets and pallet components constructed of paper material such as corrugated cardboard are suitable for supporting and transporting many products. Typical cardboard constructions cost less to manufacture and weigh less than wooden pallets. Though typical wood pallets do exhibit higher strength and durability than typical cardboard pallets, wood pallets are typically returned to a shipment supplier for reuse or broken down and discarded and thus their use includes costs that occur after their first use in delivering cargo.

Wood pallets occupy space wherever they are collected and are generally formed as one-piece constructions having rails and slats or large-area loading surfaces. They are not conveniently reduced to smaller sizes or easily disassembled for shipment and storage. A wood pallet typically represents the first use of wood, a valuable natural resource, whereas cardboard can be formed from recycled material.

Cardboard pallets are in use in industries and developments are occurring to increase their applicability, strength, and convenience.

### SUMMARY OF THE INVENTION

Accordingly, there is a need for improved pallets and pallet rails. Therefore it is an object of the present invention to provide several embodiments of a pallet rail, two or more of which are usable in spaced-apart relation to support respective portions of a rigid load to thereby form a pallet. In a first embodiment, the pallet rail includes an elongate support box, and a plurality of separately formed reinforcing tubes. The support box is formed from a paper blank that is folded along three parallel fold lines to define two laterally spaced-apart side walls, a bottom wall, and a vertically spaced-apart upper support wall for supporting a portion of the rigid load. The reinforcing tubes are positioned within the support box in spaced-apart relation along the length of the box between the bottom wall and upper support wall to reinforce the box and define the distance of the upper support wall above the bottom wall. The two side walls have arcuate corners adjacent the bottom wall to define two opposing longitudinal ends of the support box having curved lower profiles. The paper blank may also be folded along a fourth fold line that is parallel to the three parallel fold lines to define a second bottom wall overlapping the bottom wall.

In at least one example according to the first embodiment, the upper support wall has two longitudinal ends each having a central alignment notch for aligning the pallet rail under corresponding alignment notches of the rigid load. The two opposing longitudinal ends of the support box may also have notches formed for receiving and holding a wrapping material for wrapping the pallet rail and rigid load. The paper blank may be formed of corrugated paper, and the reinforcing tubes may be formed of densified paper.

In a second embodiment, the pallet rail includes an elongate support box, an adjacent end wall, and a plurality of separately-formed reinforcing tubes. The support box is formed from a paper blank that is folded along three parallel fold lines to define an inner wall, a laterally spaced-apart outer wall, a bottom wall and a vertically spaced-apart upper support wall for supporting one end of the rigid load. The adjacent end wall projects upwardly from the outer wall for engaging one end of the rigid load. The reinforcing tubes are positioned within the support box in spaced-apart relation along the length of the box between the bottom wall and upper support wall to reinforce the box and define the distance of the upper support wall above the bottom wall. There are at least two openings in the inner wall and at least two openings in the outer wall aligned with the at least two openings in the inner wall for receiving the forks of a forklift used to move the pallet.

In at least one example according to the second embodiment, an adhesive strip is positioned along the upper support wall for adhering the pallet rail to the rigid load. The pallet rail may also include longitudinally spaced-apart lateral walls extending between the openings in the inner wall and the openings in the outer wall for facing the forks of the forklift used to move the pallet. The paper blank may be formed of corrugated paper, and the reinforcing tubes may be formed of densified paper.

In a third embodiment, the pallet rail includes an elongate support box and at least one elongate reinforcing tube. The support box is formed from a paper blank that is folded along three parallel fold lines to define two laterally spaced-apart side walls, a bottom wall, and a vertically spaced-apart upper support wall for supporting a portion of the rigid load. The reinforcing tube is positioned longitudinally within the support box between the bottom wall and upper support wall to reinforce the box. The tube has a diameter that defines the distance of the upper support wall above the bottom wall.

In at least one example according to the third embodiment, the pallet rail also includes two separately-formed reinforcing tubes positioned within the support box at opposing longitudinal ends of the elongate reinforcing tube and between the bottom wall and upper support wall to reinforce the box and define the distance of the support wall above the bottom wall. The paper blank may also be folded along a fourth fold line that is parallel to the three parallel fold lines to define a second upper support wall overlapping the upper support wall.

It is also an object of the present invention to provide a method of making a pallet rail, two or more of which are usable in spaced-apart relation to support respective portions of a rigid load to thereby form a pallet. In at least one embodiment, the method includes forming a blank into a square tube having a square cross section with four sides each having substantially the same width within the square tube, and positioning a round tube having a diameter substantially the same as the width of the four sides into the square tube to reinforce the square tube. The round tube may be positioned into the square tube by inserting the round tube into a longitudinal end of the square tube, or by hinging at least one of the four sides to open the square tube and passing the round tube laterally into the open square tube.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a perspective view of a pallet according to an embodiment of the invention;

FIG. 2 is another perspective view of the pallet of FIG. 1;

FIG. 3 is yet another perspective view of the pallet of FIG. 1;

FIG. 4 is yet another perspective view of the pallet of FIG. 1;

FIG. 5 is partial perspective view of the pallet of FIG. 1;

FIG. 6 is a partial cross sectional view of the pallet of FIG. 1;

FIG. 7 is a partial perspective view of the pallet of FIG. 1;

FIG. 8 is another partial perspective view of the pallet of FIG. 1;

FIG. 9 is yet another partial perspective view of the pallet of FIG. 1;

FIG. 10 is a partial cross sectional view of the pallet of FIG. 1;

FIG. 11 is a partial cross sectional view of a pallet according to another embodiment of the invention;

FIG. 11A is a partial cross sectional view of the pallet of FIG. 11, shown in use with a second similar pallet;

FIG. 12 is another partial cross sectional view of the pallet of FIG. 11;

FIG. 13 is a perspective view of a pallet according to another embodiment of the invention;

FIG. 14 is another perspective view of the pallet of FIG. 13;

FIG. 15 is a partial cross sectional view of the pallet of FIG. 14, taken along lines 15-15;

FIG. 16 is a perspective view of a pallet according to yet another embodiment of the invention;

FIG. 17 is a top plan view of a die cut sheet for use in a method of making the pallet of FIG. 13;

FIGS. 18-21 are partial perspective views illustrating a method of making the pallet of FIG. 13;

FIG. 22 is a perspective view of a pallet according to yet another embodiment of the invention;

FIG. 23 is another perspective view of the pallet of FIG. 22;

FIG. 24 is a partial cross sectional view of the pallet of FIG. 23, taken along lines 24-24;

FIG. 25 is a perspective view of a pallet according to yet another embodiment of the invention;

FIG. 26 is a top plan view of a die cut sheet for use in a method of making the pallet of FIG. 23;

FIGS. 27-31 are partial perspective views illustrating a method of making the pallet of FIG. 23;

FIG. 32 is a perspective view of a pallet according to yet another embodiment of the invention;

FIG. 33 is a perspective view of a pallet according to yet another embodiment of the invention;

FIG. 34 is a perspective view of a paper blank used to form the pallet rail of FIG. 37;

FIG. 35 is a perspective view of the paper blank of FIG. 34 shown folded along several fold lines in a stage of forming the pallet rail of FIG. 37;

FIG. 36 is a perspective view of the paper blank of FIG. 34 folded to form an elongate support box and ready to receive reinforcing tubes;

FIG. 37 is a perspective view a pallet rail, according to a first embodiment of the present invention, having longitudinal ends with curved lower profiles.

FIG. 38 is a perspective view of a paper blank used to form the pallet rail of FIG. 40;

FIG. 39 is a perspective view of the paper blank of FIG. 38 shown folded along several fold lines in a stage of forming the pallet rail of FIG. 40;

FIG. 40 is a perspective view of a pallet rail, according to a second embodiment of the present invention, having an upwardly projecting end wall for engaging a rigid load;

FIG. 41 is a perspective view of a pallet rail, according to a third embodiment of the present invention, having an elongate support box and a longitudinally positioned reinforcing tube therein; and

FIG. 42 is a perspective view of another example of a pallet rail, having additional reinforcing tubes within the support box.

### DETAILED DESCRIPTIONS

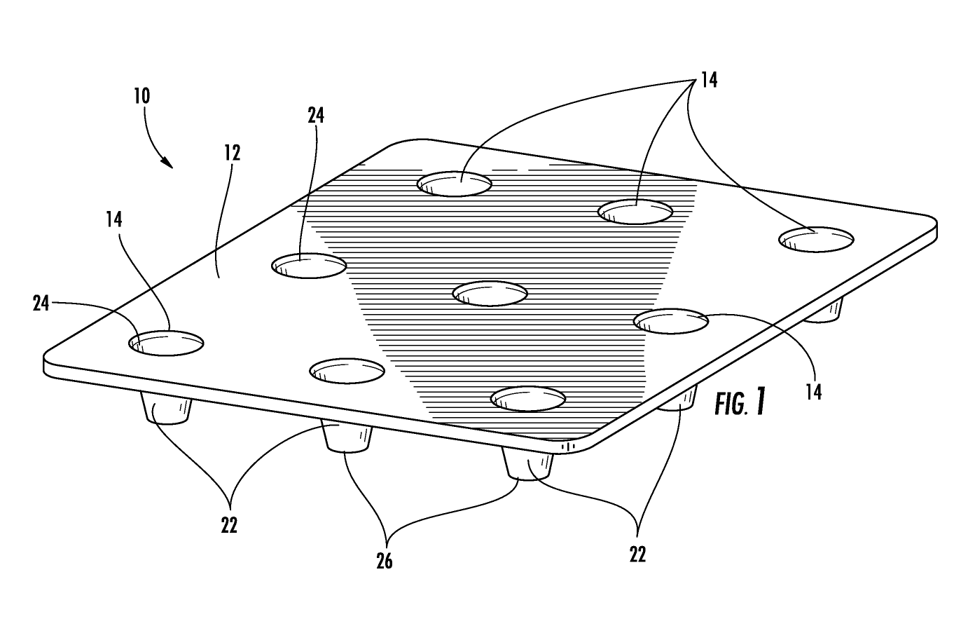

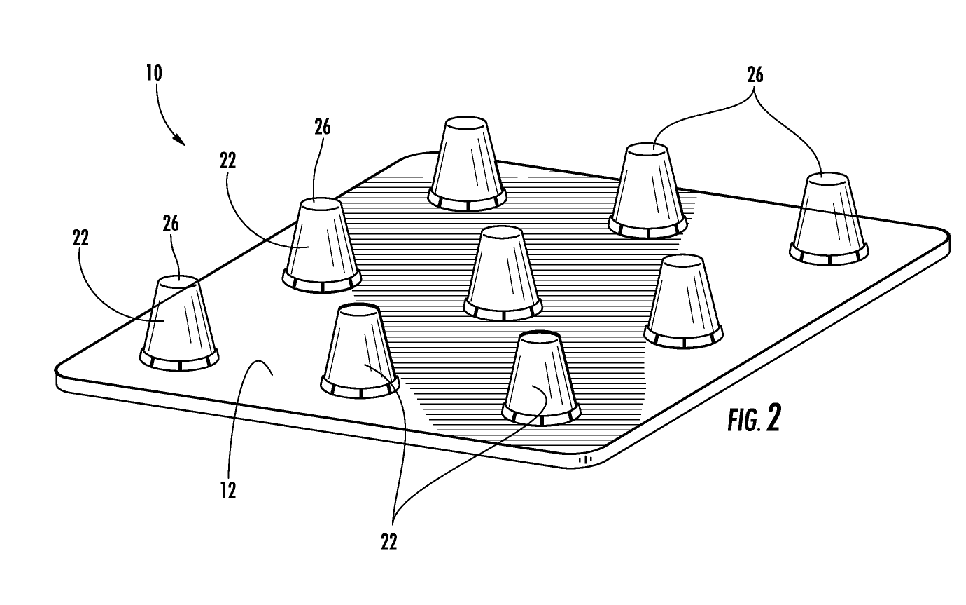

Referring to the drawings wherein identical reference numerals denote the same elements throughout the various views, a pallet according to an embodiment of the invention is illustrated in FIGS. 1-4, and shown generally at reference numeral 10. The pallet 10 includes a platform 12 with a plurality of circular openings 14 and a leg 22 positioned within each of the openings 14. The legs 22 are preferably conical and positioned such that the larger diameter end 24 of each leg 22 is connected to the platform 12, and the smaller diameter end 26 rests on the floor.

The platform 12 is formed of double wall corrugated paper having a thickness of 6.5 mm, with nine openings 14 for receiving the legs 22. Each opening 14 has a diameter of 95 mm.

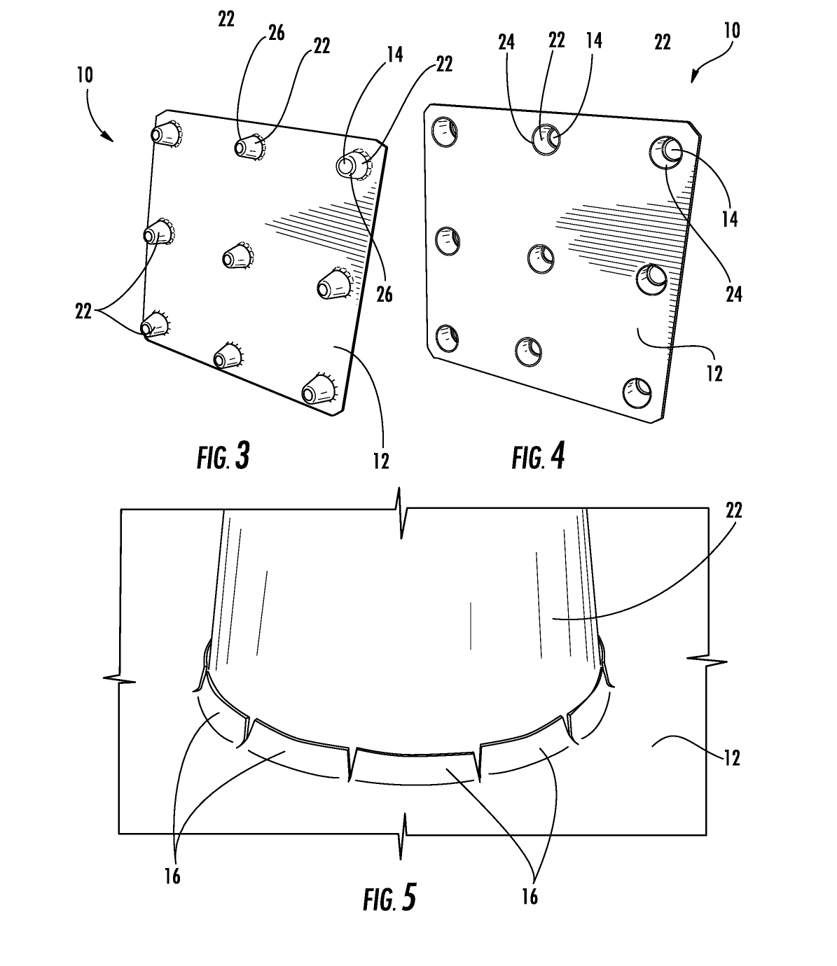

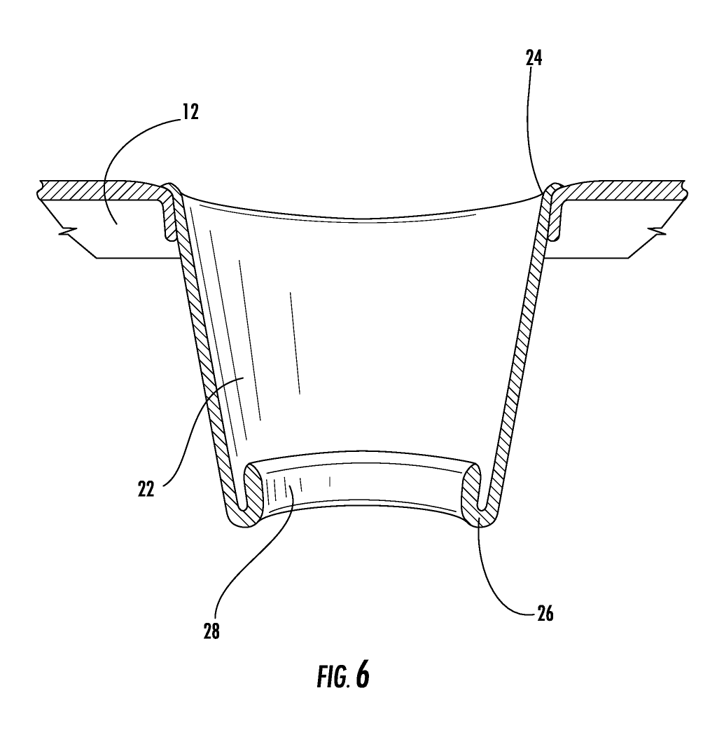

As shown in FIGS. 3 and 4, the legs 22 are conical and open at both ends 24, 26, and are tapered at an angle of about 10 degrees. The legs 22 are made of 3-3.5 laps of 380-400 g/sqm paper having a thickness of 630 microns, and have a length of 116 mm. The inner diameter of the large diameter end 24 is 100 mm, and the inner diameter of the small diameter end 26 is 59 mm. The large diameter end 24 has a radius pattern 294, and the small diameter end 26 has a radius pattern of 177. Each leg 22 preferably weighs 40.7 grams. The pallet 10 is thus conducive to recycling and disposal as it can be made completely of paper.

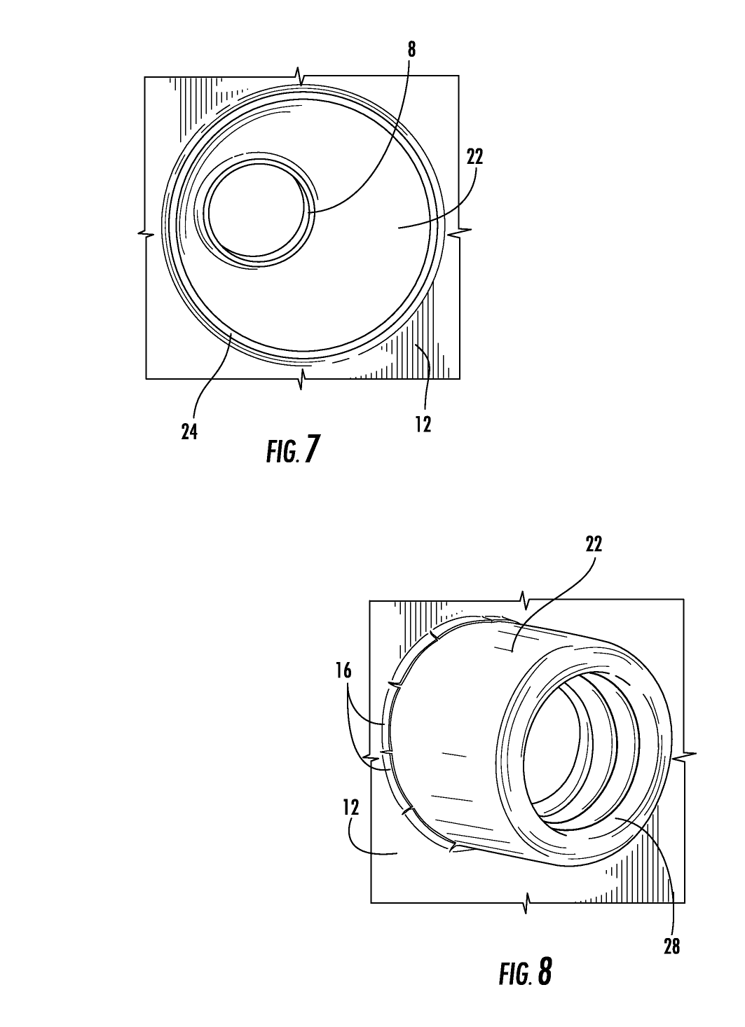

An adhesive, such as ethylene vinyl acetate (EVA) glue is sprayed or spread around the outer rim of the large diameter end 24 of the legs 22. The legs 22 are then pushed down through the openings 14. As shown in FIG. 5, the platform 12 includes foldable flap sections 16 proximate the openings 14. The openings 14 are sized such that the flap sections 16 fold downwardly and engage the large diameter end 24 of the legs 22 when the legs 22 are pushed through the openings 14. The adhesive on the legs 22 adheres to the flap sections 16 of the platform 12. Alternatively, the adhesive can be put on the flap sections 16 prior to positioning the legs 22 within the openings 14.

As shown in FIGS. 6 and 7, each leg 22 has a bull nose 28 formed at the small diameter end 26. The bull nose 28 is formed by folding a portion of the leg 22 inwardly so that the bull nose 28 extends around the circumference of the inner wall surface of the leg 22.

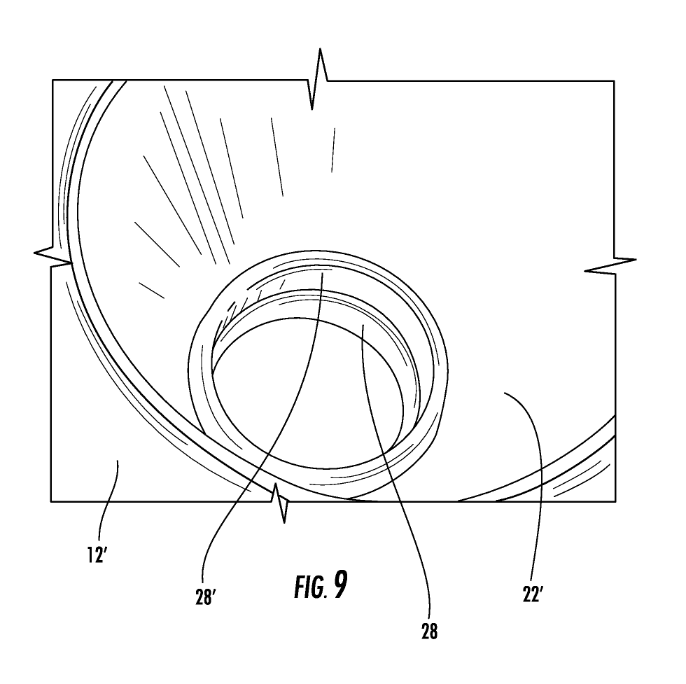

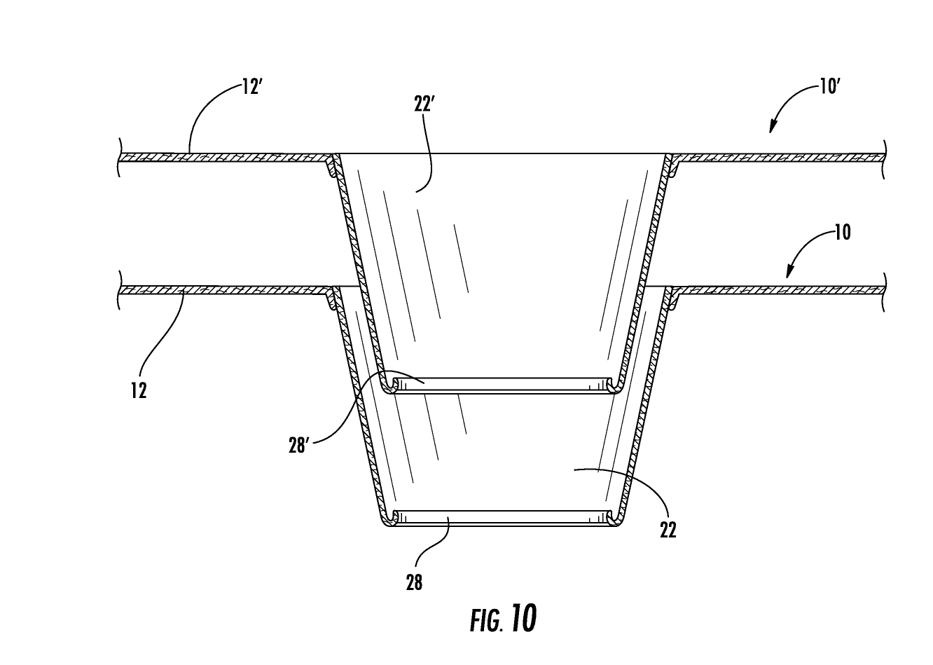

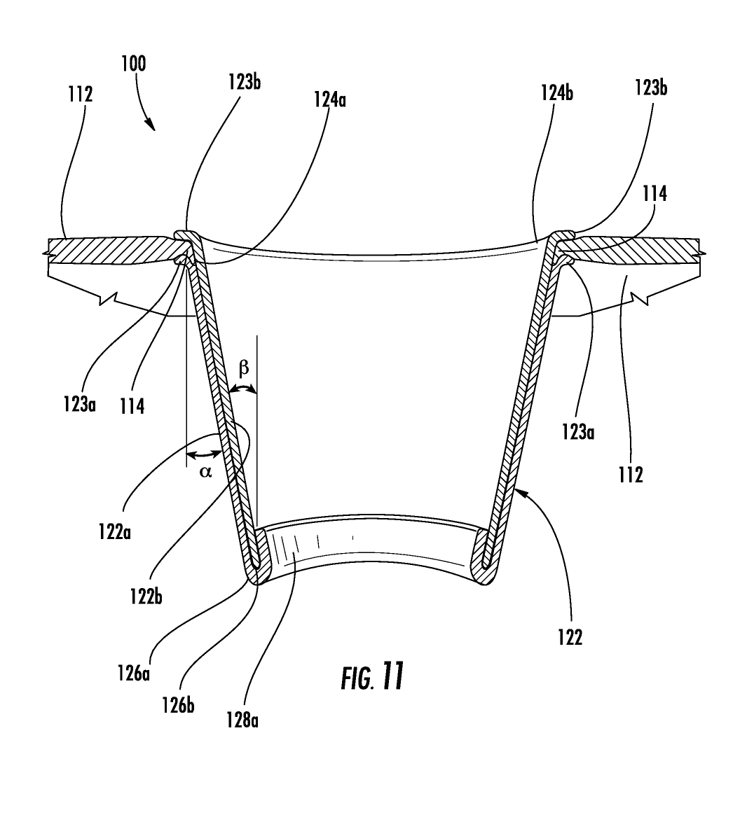

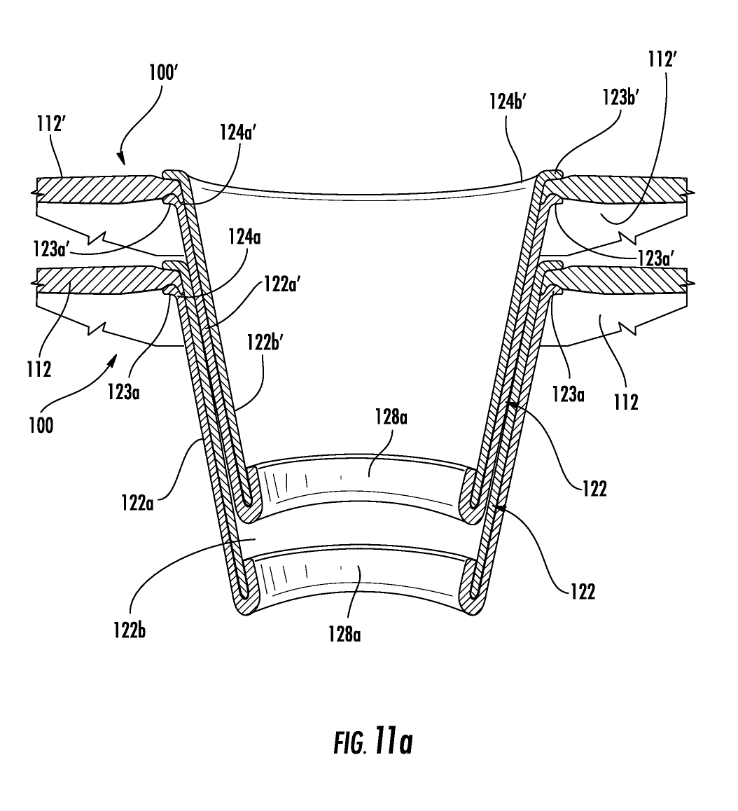

As shown in FIGS. 8-10, the pallet 10 can be nested within another like pallet 10′, and vice versa. As shown in FIGS. 9 and 10, the bull nose 28 of the first pallet 10 provides a stop for the leg 22′ of a second pallet 10′ that is being nested within the first pallet 10. As such, the second pallet 10′ is prevented from sliding all the way to the end of the leg 22 of the first pallet 10, thereby preventing the two pallets 10, 10′ from getting stuck too tightly together while in storage. This facilitates separation of the two pallets 10, 10′ when it is desired to next use the pallets 10, 10′ for material transport. Additional pallets can be nested, such as is illustrated in FIG. 8, which shows the nesting of four pallets 10.

In addition to facilitating separation of nested pallets 10, 10′, the bull nose 28 also adds radial and axial strength to the leg 22, which compensates for the absence of a bottom panel in the leg 22, enabling the pallet 10 to withstand heavier loads. Preferably, the pallet 10 can support an evenly distributed mass of about 600 kg. Furthermore, the bull nose 28 provides a smooth surface at the bottom of the leg 22 that facilitates sliding movement of the pallet 10 on a supporting surface such as the ground or floor.

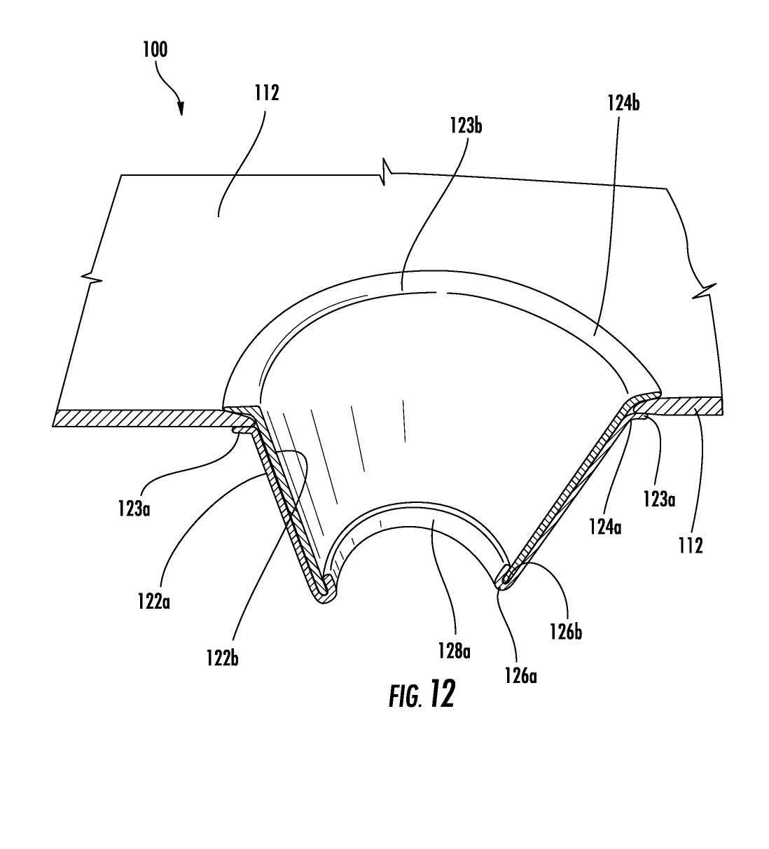

A pallet according to another embodiment of the invention is illustrated in FIGS. 11-12, and shown generally at reference numeral 100. The pallet 100 is similar in construction to the previously described pallet 10, except that each leg 122 of the pallet 100 has two cones 122a, 122b. This construction adds strength to the legs 122 and enables the pallet 100 to withstand heavier loads.

Each cone 122a, 122b has flared portions 123a, 123b, respectively, extending outward from the large diameter ends 124a, 124b of the cones 122a, 122b. An adhesive, such as ethylene vinyl acetate (EVA) glue, is sprayed or spread onto the flared portion 123a of the outer cone 122a, which is then pressed on the lower surface of the platform 112 of the pallet 100. Adhesive is sprayed at the inner surface of the small diameter end 126a of the outer cone 122a within the area between the bull nose 128a and the sidewall of the cone 122a. Adhesive is placed on the flared portion 123b of the inner cone 122b, and the inner cone 122b is positioned on top of the outer cone 122a, such that the flared portion 123b of the inner cone 122b rests on the upper surface of the platform 112. The small diameter end 126b of the inner cone 122b contacts the adhesive in the crevice of the bull nose 128a of the outer cone 122a to adhere the outer cone 122a and the inner cone 122b together. The inner cone 122b does not have a bull nose.

As shown in FIG. 11, the outer cone 122a is sloped at an angle a relative to the vertical axis that is greater than the sloped angle β of the inner cone 122b. Preferably, the angle a of the outer cone 122a is about ten degrees, and the angle β of the inner cone 122b is about eight degrees. This results in an area between the flared portions 123a, 123b of the outer cone 122a and inner cone 122b, respectively, within which a portion 114 of the platform 112 can be sandwiched.

As shown in FIG. 11A, the leg 122′ of a second pallet 100′ can be nested within the leg 122 of the pallet 100, and since the outer cone 122a′ of leg 122′ of the nesting pallet 100′ has a slightly greater angle a than the angle β of the inner cone 122b of the receiving pallet 100, the nesting pallet 100′ is not allowed to descend all the way to the very bottom of the leg 122 of the receiving pallet 100. This prevents the two pallets 100,100′ from becoming stuck to tightly together and facilitates easy separation of the two pallets 100, 100′.

The pallet 100 can be made of corrugated paper, or other suitable material including moisture resistant paper board. It should be noted that the term “paper” as used throughout this application refers generally to all kinds of paper, including cardboard.

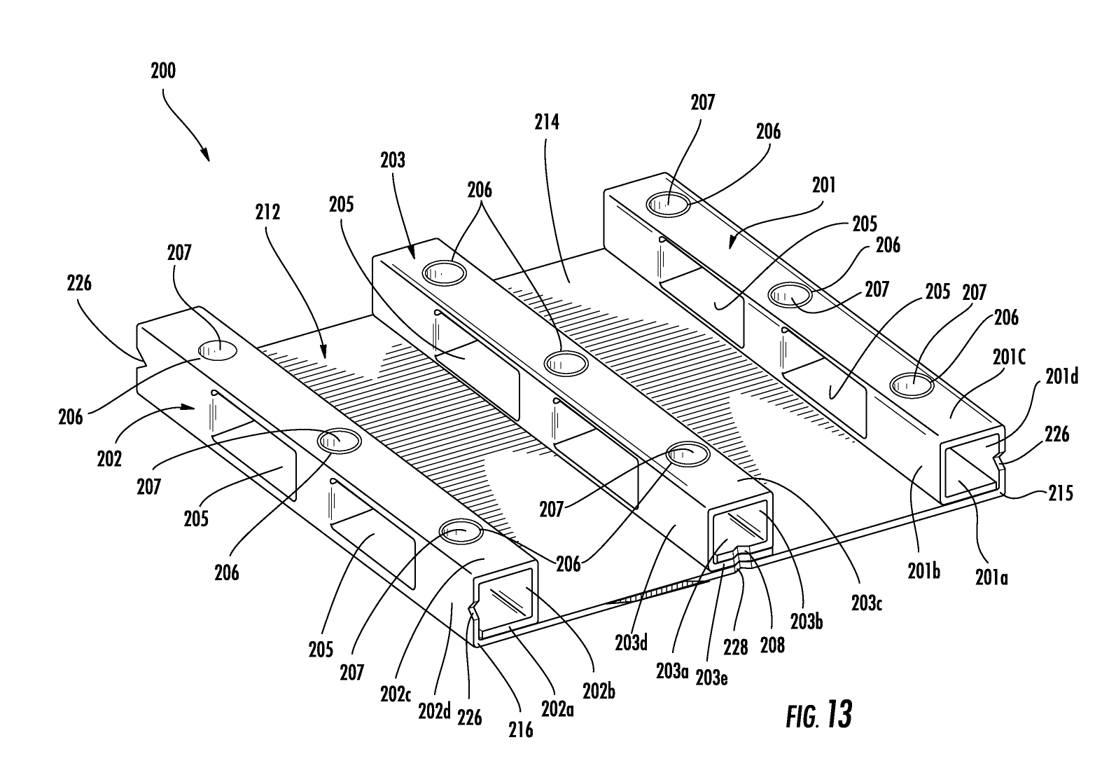

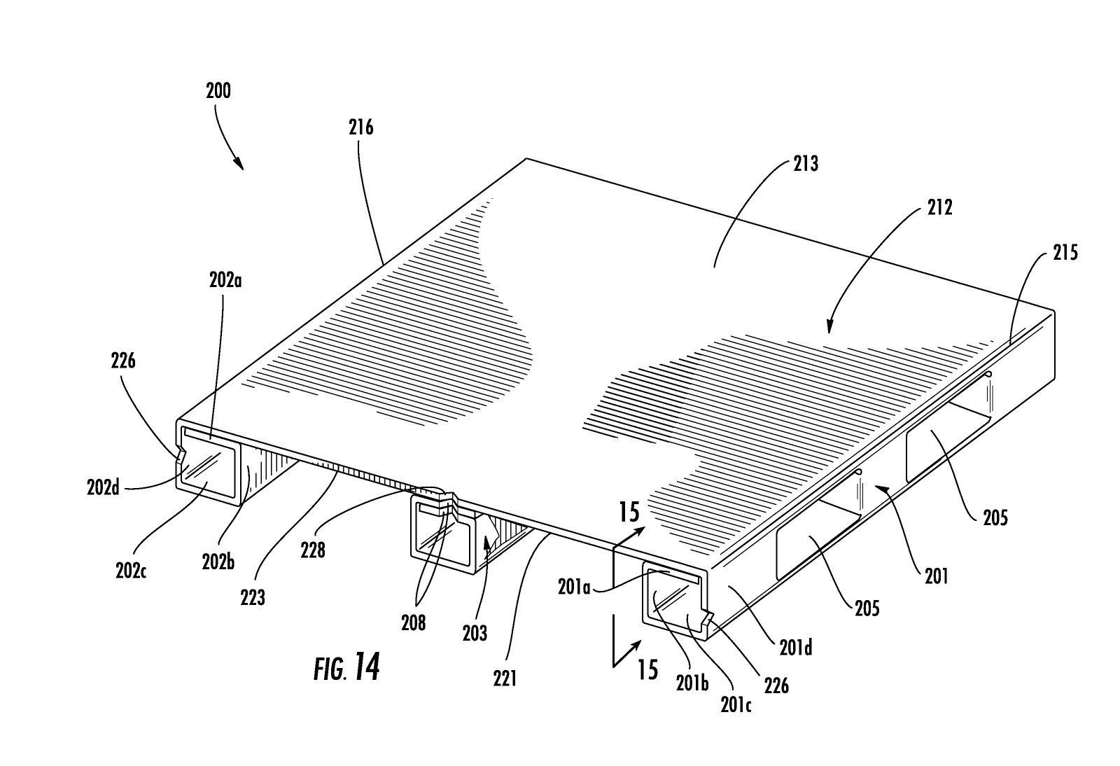

A pallet according to another embodiment of the invention is illustrated in FIGS. 13 and 14, and shown generally at reference numeral 200. The pallet 200 includes a platform 212 and three leg members 201, 202, 203.

The platform 212 has a top side 213 for carrying objects, and an under side 214 opposite the top side 213. While the platform 212 is preferably rectangular as shown in FIGS. 13 and 14, it can be a variety of suitable shapes. Three leg members 201, 202, 203 are positioned on the under side 214 of the platform in substantially parallel relation to each other. The first leg member 201 is positioned at one end 215 of the platform 212, and the second leg member 202 is positioned at the opposite end 216 of the platform 212. The third leg member 203 is positioned intermediate the first and second leg members 201, 202 at approximately the center of the platform 212. The leg members 201, 202, 203 are substantially parallel with each other.

As shown in FIG. 13, each of the three leg members 201, 202, 203 are rectangular, and extend across the width of the platform 212. As such, the first and second leg members 201, 202 are coextensive with the first and second ends 215, 216, respectively, of the platform 212.

The first and second leg members 201, 202 each have four walls 201a-d, 202a-d, respectively. The third leg member 203 has a total of five walls 203a-e. While the leg members 201, 202, 203 are preferably rectangular, they can be a variety of shapes, such as conical, triangular or other polygonal shape. In addition, the number of leg members can be varied.

The first walls 201a, 202a, 203a of the leg members 201, 202, 203 lie flat on the under side 214 of the platform 212. The second walls 201b, 202b, 203b extend perpendicularly from the first walls 201a, 202a, 203a and the third walls 201c, 202c, 203c extend perpendicularly from the second walls 201b, 202b, 203b. The fourth walls 201d, 202d, 203d extend perpendicularly from the third walls 201c, 202c, 203c back toward the underside 214 of the platform 212. The fifth wall 203e of the third leg member 203 extends perpendicularly from the fourth wall 203d and lies parallel to and flat on the first wall 203a.

Each of the leg members 201, 202, 203 can have a pair of rectangular openings 205 formed in the second and fourth walls 201b, 201d, 202b, 202d, 203b, 203d of the leg members 201, 202, 203 and aligned on a horizontal axis that is substantially parallel with the platform 212. As such, fork-lift forks can be inserted through the openings 205 to engage and lift the pallet 200. Furthermore, the pallet 200 can be accessed by fork-lift forks from all four sides of the pallet by either inserting the fork-lift forks through the openings 205 in the leg members 201, 202, 203, or by insertion of forks in the space 221 between the first and third leg members and the space 223 between second and third leg members.

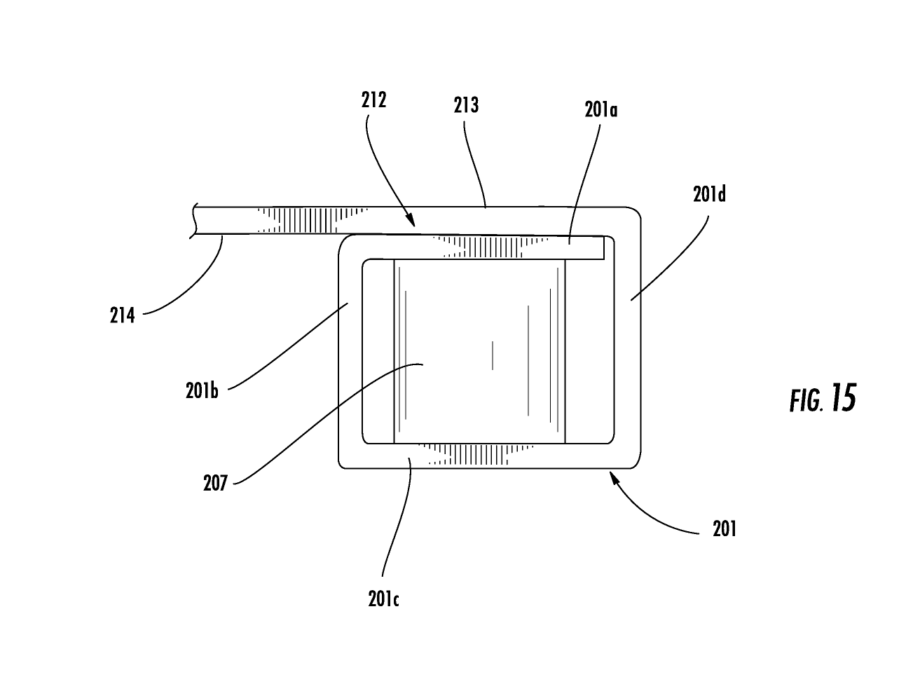

Each of the leg members 201, 202, 203 can have a plurality of openings 206 formed on the third wall 201c, 202c, 203c of the leg members 201, 202, 203. A support member, such as a conical paper tube 207, can be positioned within each of the openings 206. The tubes 207 are positioned within the openings 206 of the leg members 201, 202, 203 such that the tubes 207 reside in perpendicular relation to the platform 212, as shown in FIG. 15. The tubes 207 provide added strength and stability to the leg members 201, 202, 203 to enable the pallet 200 to carry heavier loads.

The leg members 201, 202, 203 can be positioned directly on a ground surface and thereby support the platform 212 above the ground surface. Alternatively, the leg members 201, 202, 203 can be mounted on a substantially flat base member 220, as shown in FIG. 16. The base member 230 can be positioned on a ground surface.

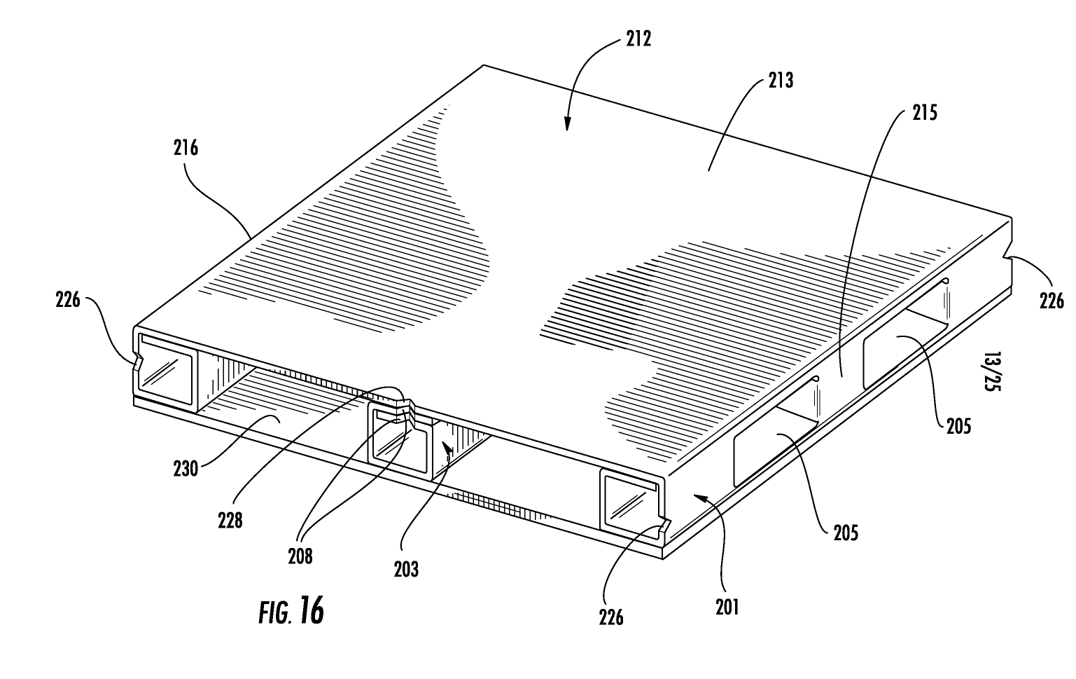

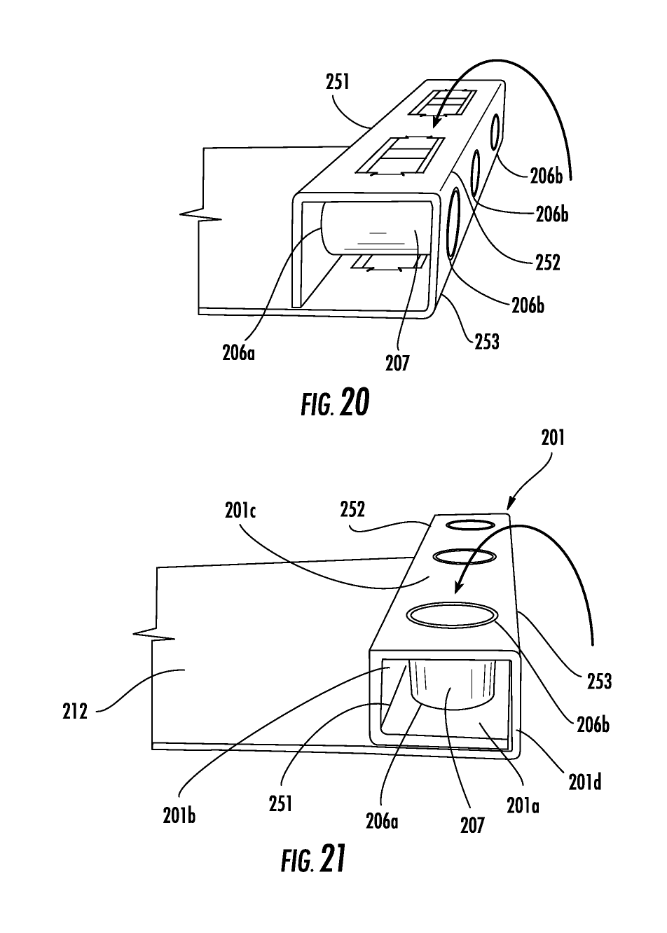

A method of making the pallet 200 is illustrated in FIGS. 17-21. A blank sheet of material, such as a paper die cut sheet 222, is provided as shown in FIG. 17. Four fold lines 251, 252, 253, 254 are formed at one end 215 of the sheet 222, and four fold lines 261, 262, 263, 264 are formed at the opposite end 216 of the sheet. Perforated sections 225 are positioned between the first and second fold lines 251, 261, 252, 262, and between the third fold lines 253, 263 and fourth fold lines 254, 264 of the sheet 222. A first plurality of linearly aligned circular openings 206a are formed between the first and second ends 215, 216 of the sheet 222 and the first fold lines 251, 261, respectively, of the sheet 222. A second plurality of linearly aligned circular openings 206b are formed between the second fold lines 252, 262 and the third fold lines 253, 263 of the sheet 222.

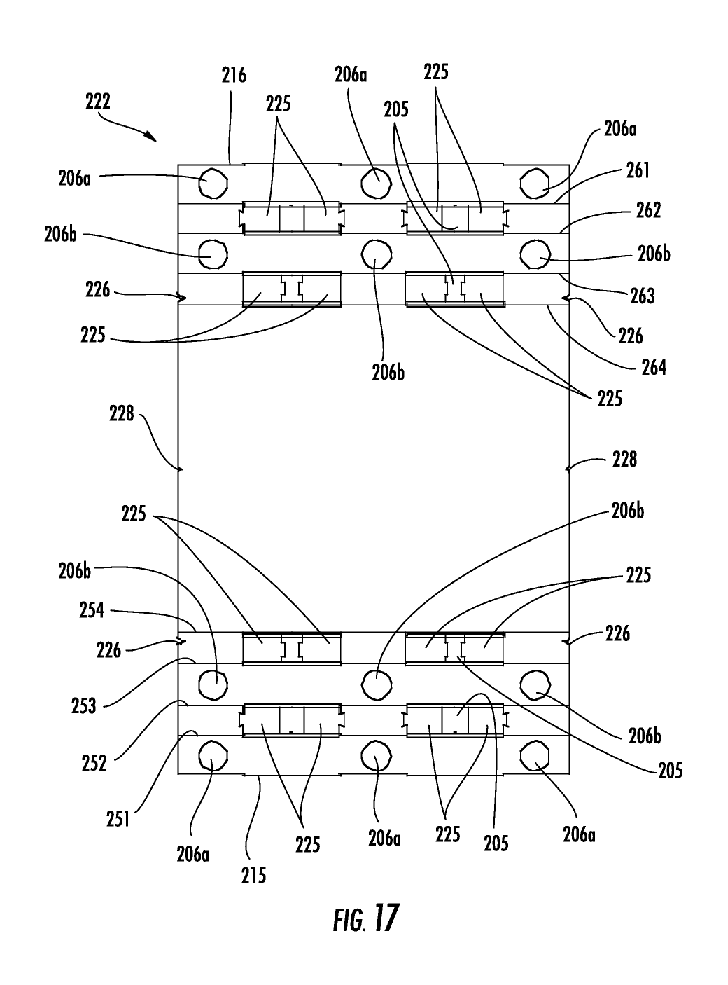

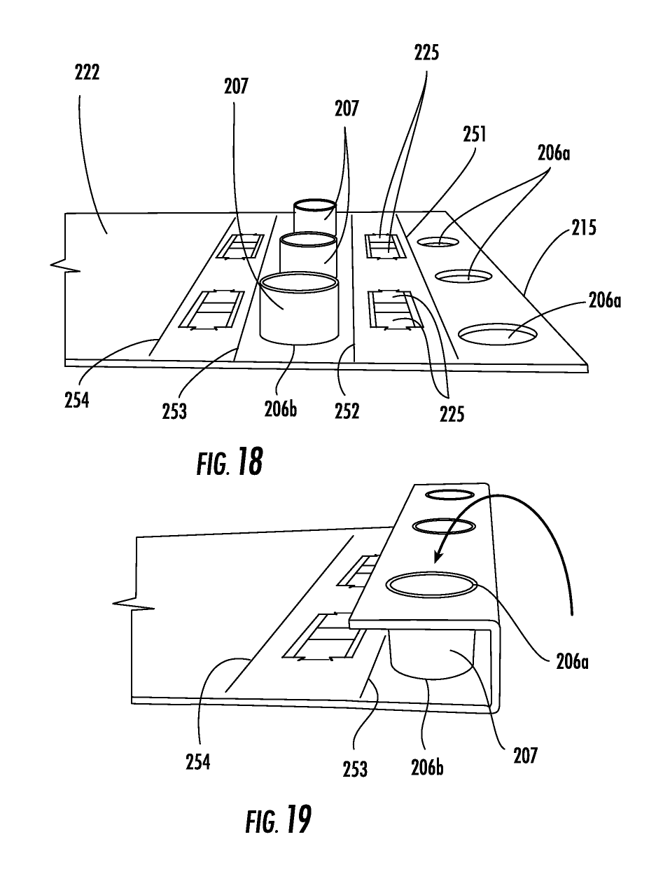

As shown in FIG. 18, the bottom of the support tubes 207 are positioned within circular openings 206b on the sheet 222. The first end of the 215 of the sheet 222 is folded over at ninety degree angles at the first and second fold lines 251, 252 such that the top of the support tubes 207 are positioned within the circular openings 206a, as shown in FIG. 19. The support tubes 207 have a diameter slightly less than the diameter of the openings 206a, 206b such that the tubes 207 are held in place within the openings 206a, 206b by frictional engagement. The sheet 222 is folded at ninety degree angles at the third and fourth fold lines 253, 254 to form the rectangular leg member 201 having four walls 201a-d, shown in FIG. 21. An adhesive can be applied to the sheet 222 to attach wall 201a thereto. Alternatively, other suitable attachment means can be employed to hold the leg member 201, such as staples, nails or other fasteners. The second leg member 202 is made in the same manner as the first leg member 201, and therefore the process is not described again here.

As shown in FIG. 17, the sheet 222 has two pairs of notches 226 formed at opposite ends of the sheet 222 between the third fold lines 253, 263 and the fourth fold lines 254, 264. When the sides 215, 216 of the sheet 222 are folded to form the leg members 201, 202 as described above, the notches 226 are positioned at the four corners of the pallet 200 on the fourth walls 201d, 202d of the leg members 201, 202, respectively, as shown in FIG. 13. These notches 226 provide an area for receiving and holding a wrapping material, such as polyvinylidene chloride or other plastic wrap that is to be wrapped around the pallet 200 and the objects being carried on the pallet 200.

The third leg member 203 is a separate piece that can be attached at the center for the sheet 222 between the first end 215 and second end 216. As shown in FIG. 17, the sheet 222 has two notches 228 located at opposite sides of the center of the sheet 222. The third leg member 203 likewise has notches 208 at opposite ends formed in the center of the first and fifth walls 203a, 203e. As such, proper positioning of the third leg member 203 on the sheet 222 is readily obtained by aligning the notches 208 of the leg member 203 with the notches 228 of the sheet 222, as shown in FIGS. 13 and 14. The third leg member 203 can be held in place on the sheet 222 by an adhesive placed on the first wall 203a of the leg member 203 or the sheet 222. Alternatively, other attachment means can be employed such as staples, nails or other fasteners.

When the first and second leg members 201, 202 have been formed, the perforated sections 225 can be partially detached therefrom to form flaps that can be folded inwardly into the leg members 201, 202 to form the openings 205, shown in FIG. 13. The flap sections can be held within the leg members 201, 202 by frictional engagement with the first walls 201a, 202a and third walls 201c, 202c of the leg members 201, 202, respectively.

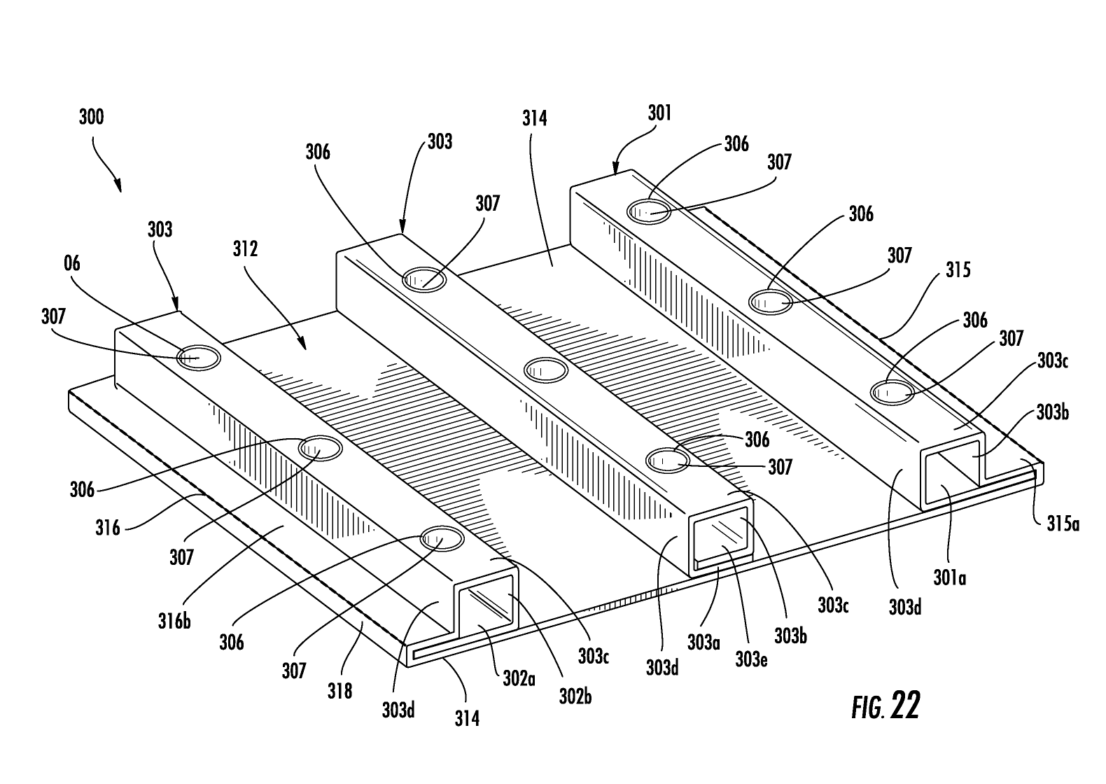

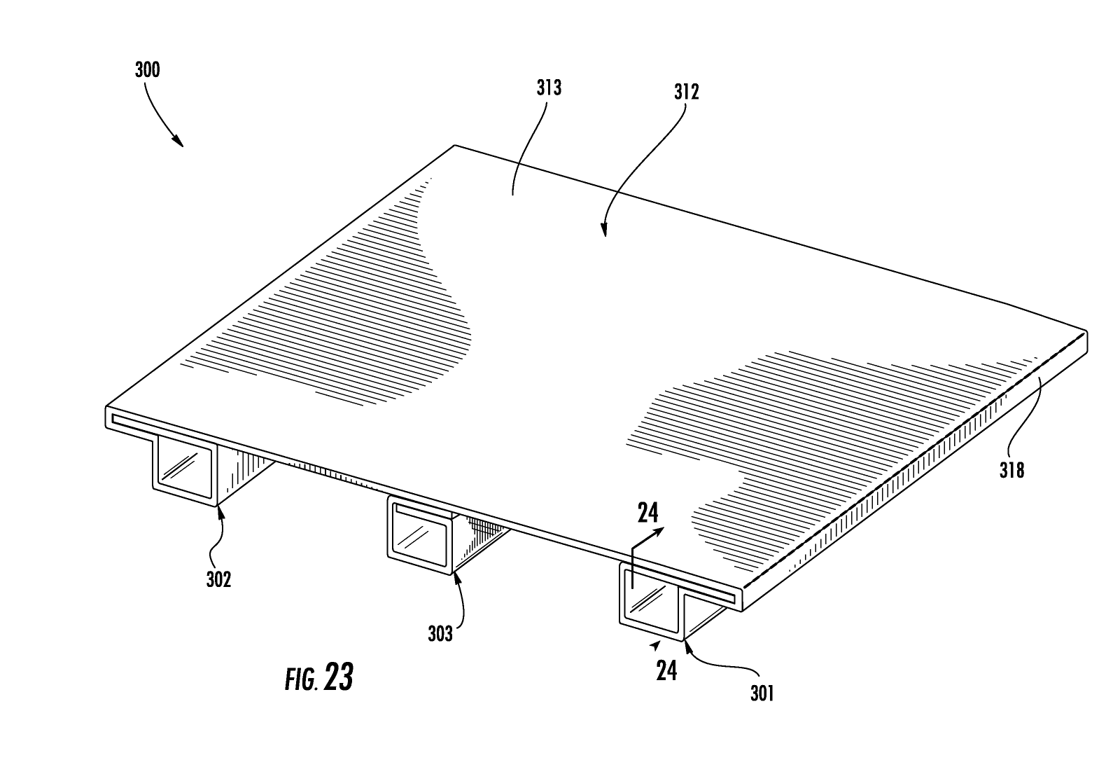

A pallet according to yet another embodiment of the invention is illustrated in FIGS. 22 and 23, and shown generally at reference numeral 300. The pallet 300 includes a platform 312 and three leg members 301, 302, 303.

The platform 312 has a top side 313, shown in FIG. 23, for carrying objects thereon, and an under side 314, shown in FIG. 22, opposite the top side 313. While the platform 312 is preferably rectangular, it can be a variety of suitable shapes. Three leg members 301, 302, 303 are positioned on the under side 314 of the platform in substantially parallel relation to each other. The first leg member 301 is positioned proximate one end 315 of the platform 312, and the second leg member 302 is positioned proximate the opposite end 316 of the platform 312. The third leg member 303 is positioned intermediate the first and second leg members 301, 302 at approximately the center of the platform 312. The leg members 301, 302, 303 are substantially parallel with each other.

The three leg members 301, 302, 303 are rectangular, and extend across the width of the platform 312, as shown in FIG. 22. The first and second leg members 301, 302 each have four walls 301a-d, 302a-d, respectively. The third leg member 303 has a total of five walls 303a-e. While the leg members 301, 302, 303 are preferably rectangular, they can be a variety of shapes, such as conical, triangular or other polygonal shape. In addition, the number of leg members can be varied.

The first walls 301a, 302a, 303a of the leg members 301, 302, 303 lie flat on the under side 314 of the platform 312. The second walls 301b, 302b, 303b extend perpendicularly from the first walls 301a, 302a, 303a and the third walls 301c, 302c, 303c extend perpendicularly from the second walls 301b, 302b, 303b. The fourth walls 301d, 302d, 303d extend perpendicularly from the third walls 301c, 302c, 303c back toward the underside 314 of the platform 312, as shown in FIG. 22. The fifth wall 303e of the third leg member 303 extends perpendicularly from the fourth wall 303d and lies parallel to and flat on the first wall 303a.

The platform 312 includes wing sections 315a, 316a at opposite ends 315, 316, respectively, as shown in FIGS. 22 and 23. As shown in FIG. 22, the wing sections 315a, 316a extend outward perpendicularly from. the fourth walls 301d, 302d of the first and second leg members 301, 302, respectively.

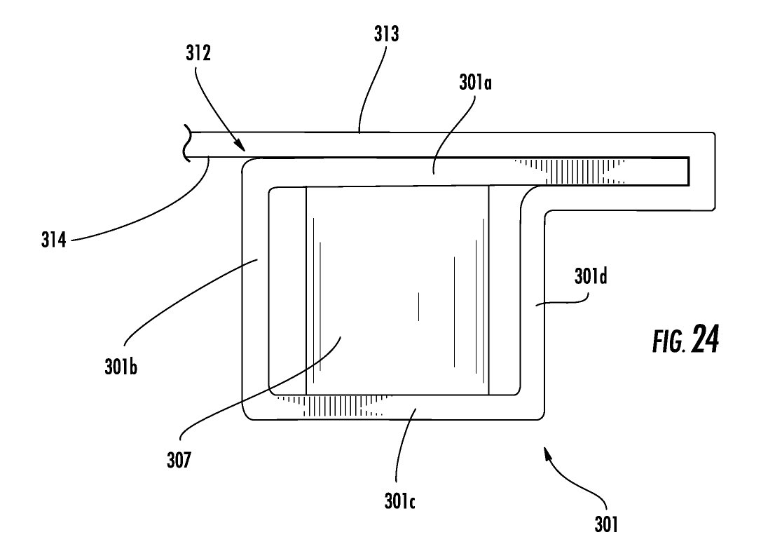

Each of the leg members 301, 302, 303 can have a plurality of openings 306 formed on the third wall 301c, 302c, 303c of the leg members 301, 302, 303. A support member, such as conical paper tubes 307, can be positioned within the openings 306. The tubes 307 are positioned within the openings 306 of the leg members 301, 302, 303 such that the tubes 307 reside in perpendicular relation to the platform 312, as shown in FIG. 24. The tubes 307 provide added strength and stability to the leg members 301, 302, 303 to enable the pallet 300 to carry heavier loads.

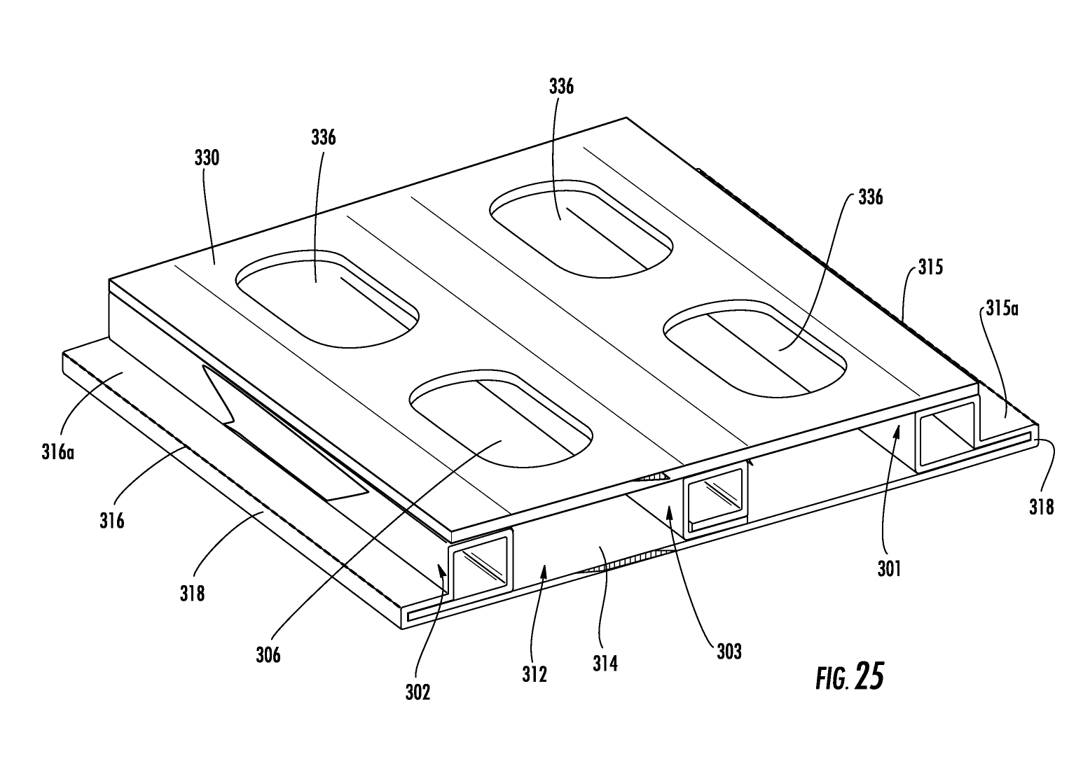

The leg members 301, 302, 303 can be positioned directly on a ground surface and thereby support the platform 312 above the ground surface. Alternatively, the leg members 301, 302, 303 can be mounted on a substantially flat base member 330, as shown in FIG. 25. The base member 330 can be attached to the leg members 301, 302, 303 using an adhesive or other attachment means, such as staples, nails or other fasteners. The base member 330 can be positioned on a ground surface, and can include openings 336, which are shaped and sized to receive a pallet jack.

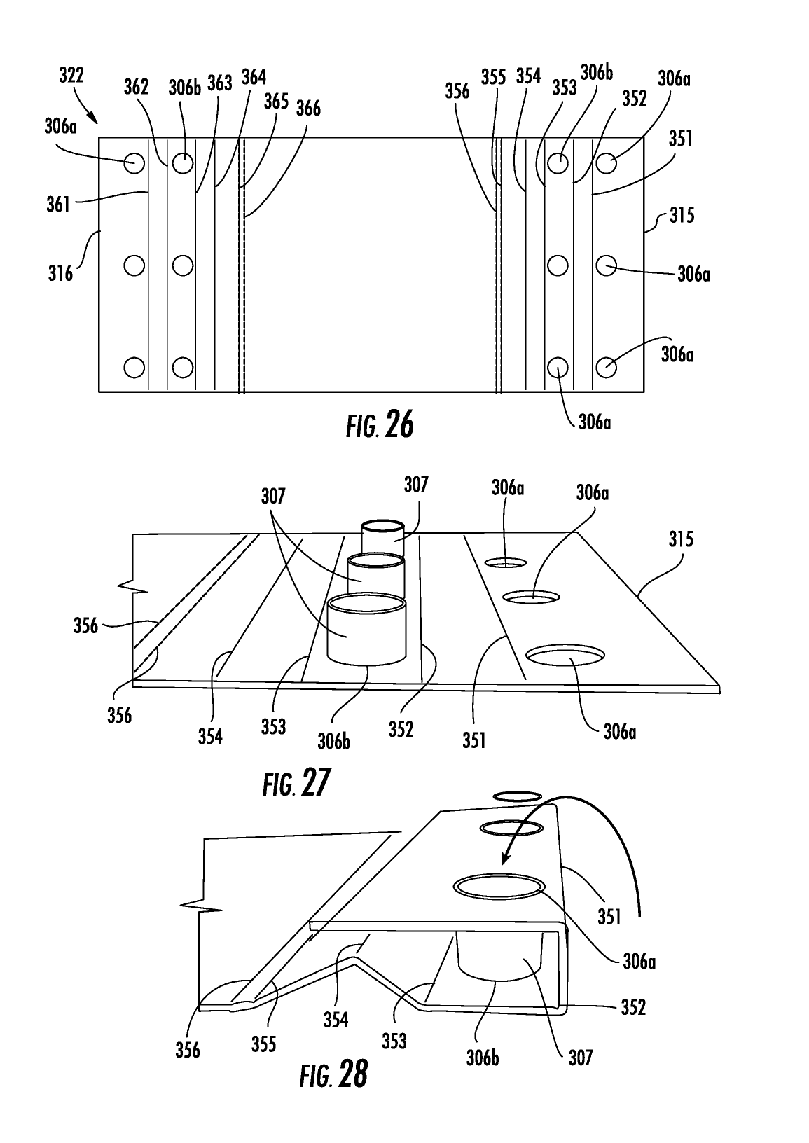

A method of making the pallet 300 is illustrated in FIGS. 26-31. A blank sheet of material, such as a paper die cut sheet 322, is provided as shown in FIG. 26. Six fold lines 351, 352, 353, 354, 355, 356 are formed at one end 315 of the sheet 322, and six fold lines 361, 362, 363, 364, 365, 366 are formed at the opposite end 316 of the sheet 322. A first plurality of linearly aligned circular openings 306a are formed between the first and second ends 315, 316 of the sheet 322 and the first fold lines 351, 361, respectively, of the sheet 322. A second plurality of linearly aligned circular openings 306b are formed between the second fold lines 352, 362 and the third fold lines 353, 363 of the sheet 322.

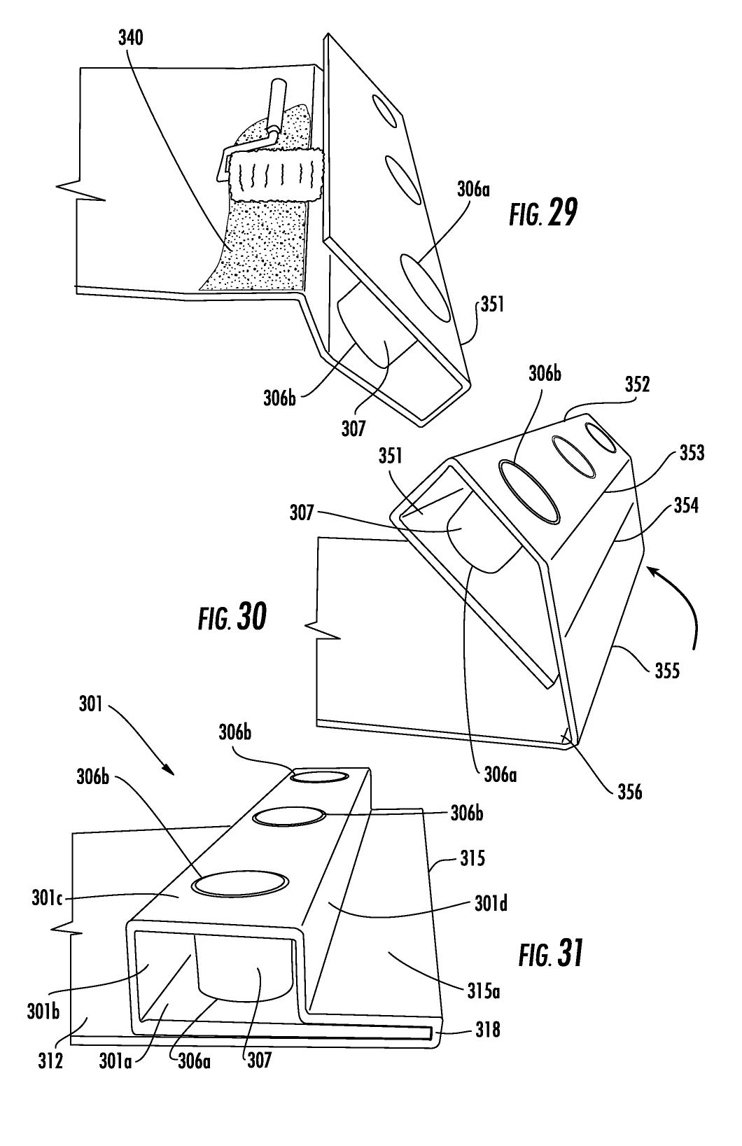

As shown in FIG. 27, the bottom of the support tubes 307 are positioned within circular openings 306b on the sheet 322. The first end 315 of the sheet 322 is folded over at ninety degree angles at the first and second fold lines 351, 352 such that the top of the support tubes 307 are positioned within the circular openings 306a, as shown in FIG. 28. The support tubes 307 have a diameter slightly less than the diameter of the openings 306a, 306b such that the tubes 307 are held in place within the openings 306a, 306b by frictional engagement. As shown in FIG. 30, the sheet 322 is folded at ninety degree angles at the third and fourth fold lines 353, 354 to form the rectangular leg member 301 having four walls 301a-d, shown in FIG. 31. The sheet is folded at ninety degree angles at the fifth and sixth fold lines 355, 356 to form a side edge 318 that joins the top side 313 and under side 314 of the platform 322.

As shown in FIG. 26, the distance between the end 315 of the platform 322 and the first fold line 351 is greater than the distance between the first and second fold lines 351, 352, second and third fold lines 352, 353, and third and fourth fold lines 353, 354. The relatively greater distance between the end 315 of the platform 322 and the first fold line 351 result in the formation of the wing section 315a extending outward from the leg member 301.

An adhesive can be applied to the sheet 322 to attach wall 301a thereto, as shown in FIG. 29. Alternatively, other suitable attachment means can be employed to hold the leg member 301 to the platform 322, such as staples, nails or other fasteners. The second leg member 302 is made in the same manner as the first leg member 301, and therefore the process is not described again here.

The third leg member 303 is a separate piece that can be attached at the center for the sheet 322 between the first end 315 and second end 316 of the platform 322. The third leg member 303 can be held in place on the sheet 322 by an adhesive 340 placed on the first wall 303a of the leg member 303 or the sheet 322. Alternatively, other attachment means can be employed such as staples, nails or other fasteners.

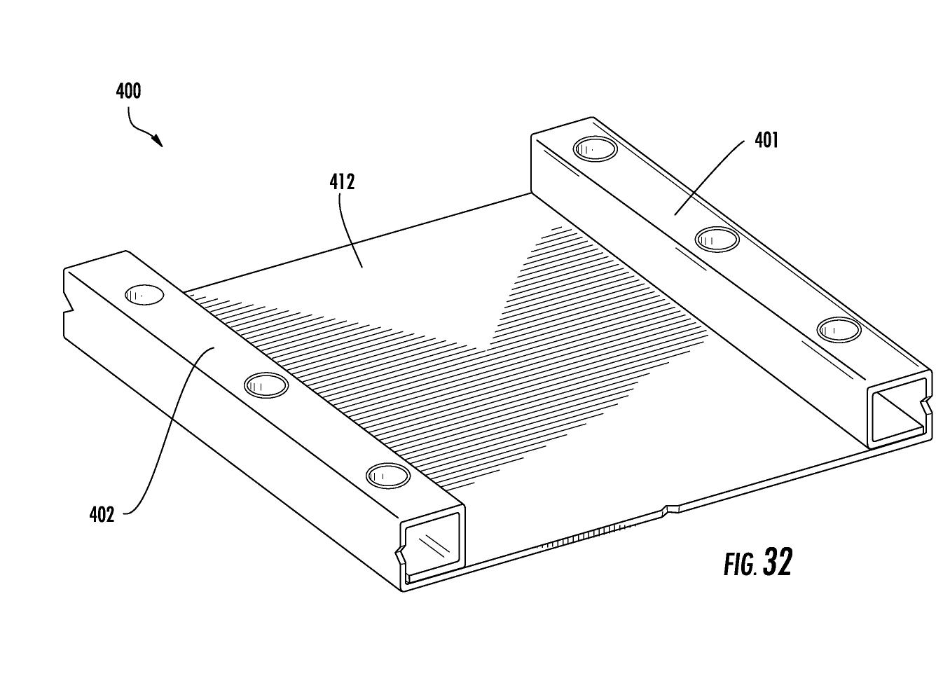

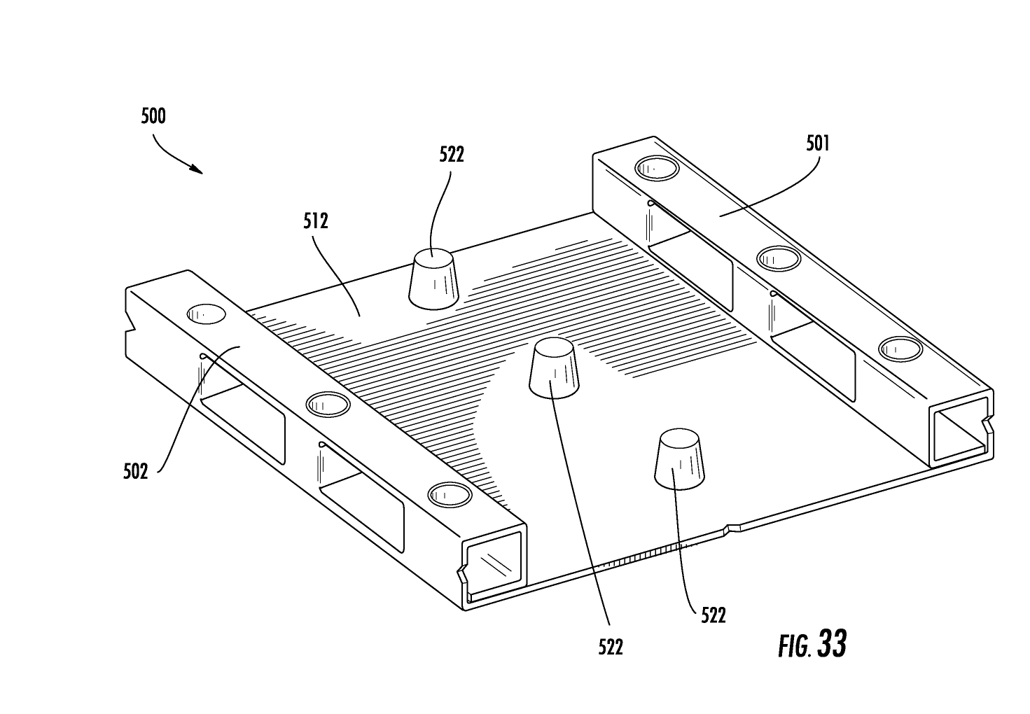

Yet another alternative embodiment of the invention is illustrated in FIG. 32, and shown generally at reference numeral 400. The pallet 400 includes a platform 412 and two leg members 401, 402, and is similar to the previously described pallet 200, but does not have a third leg member between the first and second leg members 401, 402. One advantage of pallet 400 is that it can be made entirely of a single sheet of paper or other suitable material.

A pallet according to yet another embodiment of the invention is illustrated in FIG. 33, and shown generally at reference numeral 500. The pallet 500 includes a platform 512, and two elongate rectangular leg members 501, 502. A plurality of conical leg members 522 are positioned between the two elongate rectangular leg members 501, 502, and are arranged in a line that is parallel with the rectangular leg members 501, 502. Although leg members 522 are conical, the leg members 522 can be other shapes such as tubular or square.

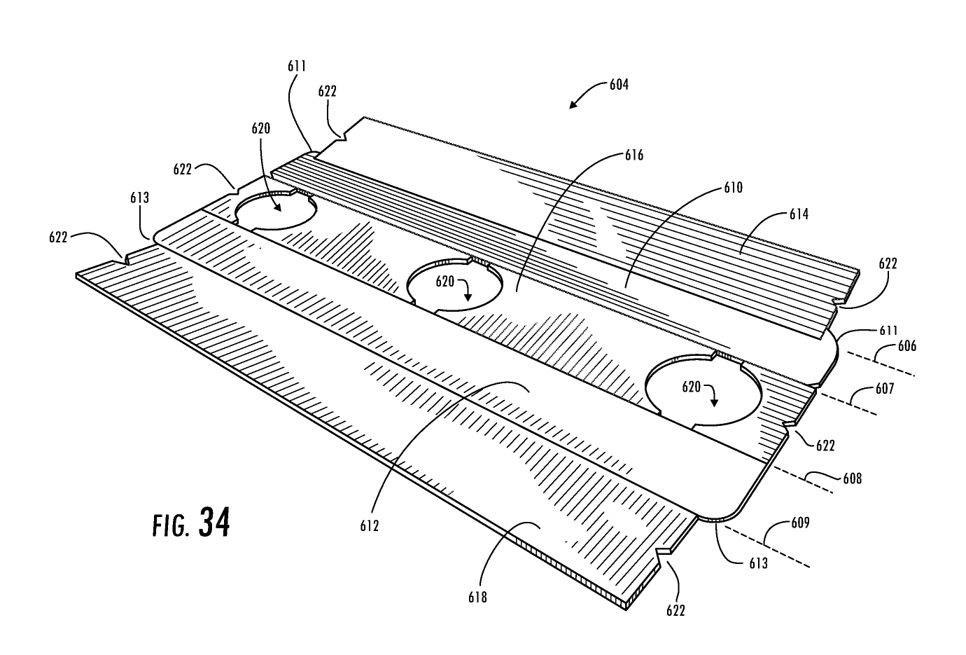

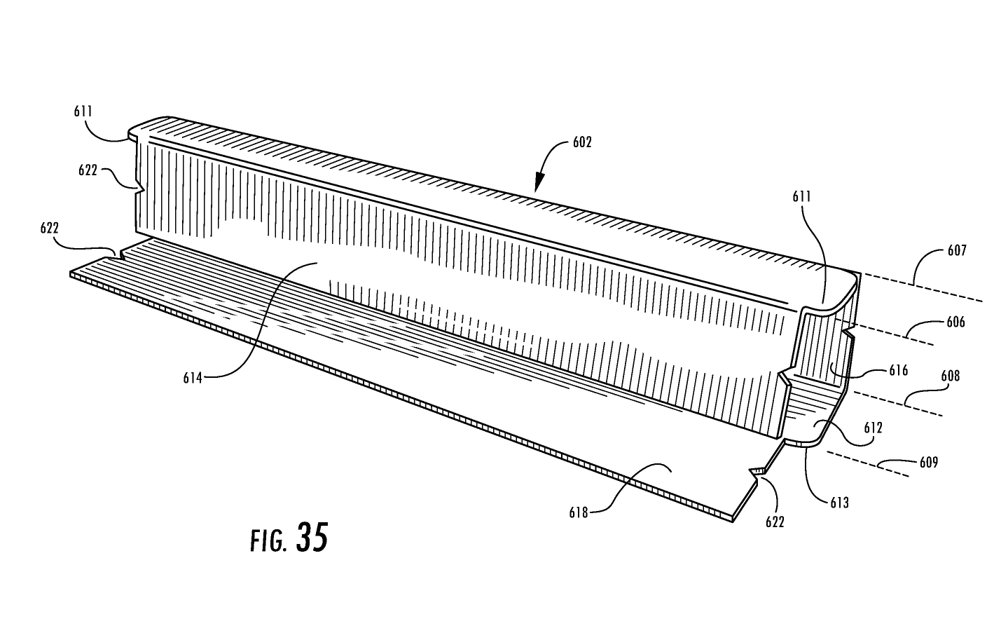

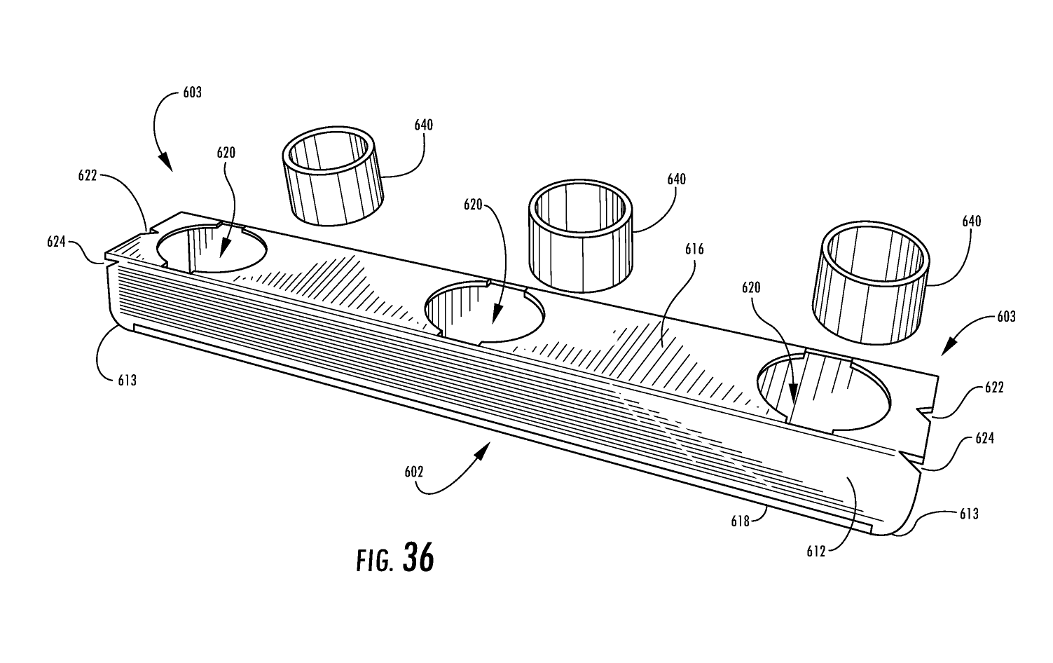

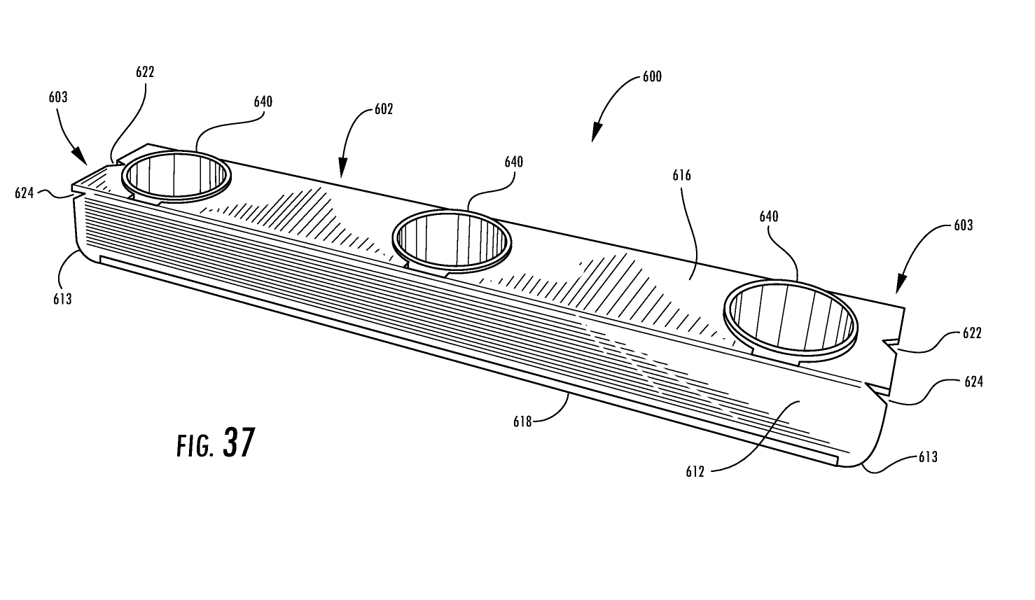

A pallet rail 600 according to at least one embodiment of the invention is shown in various stages of assembly in FIGS. 34-36, and is shown assembled in FIG. 37. Two or more of the assembled pallet rails 600 are usable in spaced-apart relation to support a rigid load and to form a pallet with the load. The assembled pallet rail 600 includes an elongate support box 602 and a plurality of separately-formed reinforcing tubes 640, which are shown in FIG. 36 prior to being positioned in the support box 600 to form the reinforced pallet rail shown in FIG. 37.

To form the support box 602, a paper blank 604 is folded along three parallel fold lines 606, 607 and 608 as shown in FIGS. 34-35 to define walls of the support box 602. The support box 602 has two laterally spaced-apart side walls 610 and 612, a bottom wall 614, and a vertically spaced-apart upper support wall 616 for supporting a rigid load. In the illustrated embodiment, the paper blank 602 is folded along a fourth fold line 609 that is parallel to the three fold lines 606-608 to define a second bottom wall 618 (FIG. 35) overlapping the bottom wall 614 as shown in FIG. 36.

The first and second bottom walls 614 and 618 may be fixed into their illustrated overlapping relation by an adhesive such as ethylene vinyl acetate (EVA) glue that is sprayed or spread onto either or both of their mutually contacting surfaces. Other adhesives and mechanical connectors such as staples can also be used. By fixing the first and second bottom walls together, the support box 602 is fixed in its assembled state as shown in FIG. 36.

The upper support wall 616 has multiple openings 620 as shown in FIG. 36, having at least arcuate circular portions, for receiving the reinforcing tubes 640 and retaining the reinforcing tubes 640 in a friction-fit engagement within the support box 602 as shown in FIG. 37. The reinforcing tubes 640 are positioned within the support box 602 in spaced-apart relation along the length of the support box 602 between the bottom wall 614 and upper support wall 616 to reinforce the support box 602 and to define the distance of the upper support wall 616 above the bottom wall 614. This construction enables the pallet rail 600 to withstand heavier loads. The reinforcing tubes can be fixed into their illustrated positions by use of an adhesive such as ethylene vinyl acetate (EVA) glue fixing each to the bottom wall 614. Other adhesives and mechanical connectors such as staples can also be used.

Advantageously, the two sidewalls 610 and 612 have arcuate corners 611 (FIG. 34) and 613 at their longitudinal ends. Thus, the longitudinal ends 603 of the support box 602 have curved lower profiles as shown in FIG. 37. This feature minimizes jamming of the pallet rail 600 as it is moved manually or in an automated environment and, for example, when the pallet rail 600 is slid into position under a load.

The notches 622 defined by the longitudinal ends 603 of the support box 602 represent another advantageous feature of the inventive pallet rail 600. The notches 622 are formed in the longitudinal ends of the upper support wall 616, the bottom wall 614, and the second bottom wall 618, for aligning the pallet rail under corresponding alignment notches of a rigid load or other support member used in conjunction with the pallet rail 600 to define a palletized load. For example, the platform 212 of FIG. 16 has alignment notches 228 by which the pallet rail 600 (FIG. 37) could be aligned with the platform 212 to support the platform in lieu of the leg member 203.

The notches 624 defined by the longitudinal ends 603 of the support box 602 represent another advantageous feature of the inventive pallet rail 600. The notches 622 are formed in the longitudinal ends of the sidewalls 610 and 612 for receiving and holding a wrapping material when the pallet rail 600 is to be wrapped with a load. This feature is particularly advantageous as a wrapping material is pulled manually from a wide roll and wrapping of a palletized load begins.

The paper blank 604 can be made of corrugated paper, or other suitable material including moisture resistant paper board. It should be noted that the term “paper” as used here refers generally to all kinds of paper, including cardboard. The paper blank 604 may be die cut or otherwise prepared from a single planar sample of material or may be assembled from several strips joined, for example along the fold lines illustrated in FIG. 34. The reinforcing tubes 640 may be formed of densified paper. For example, the reinforcing tubes 640 may be formed as laminated layered rolls of paper.

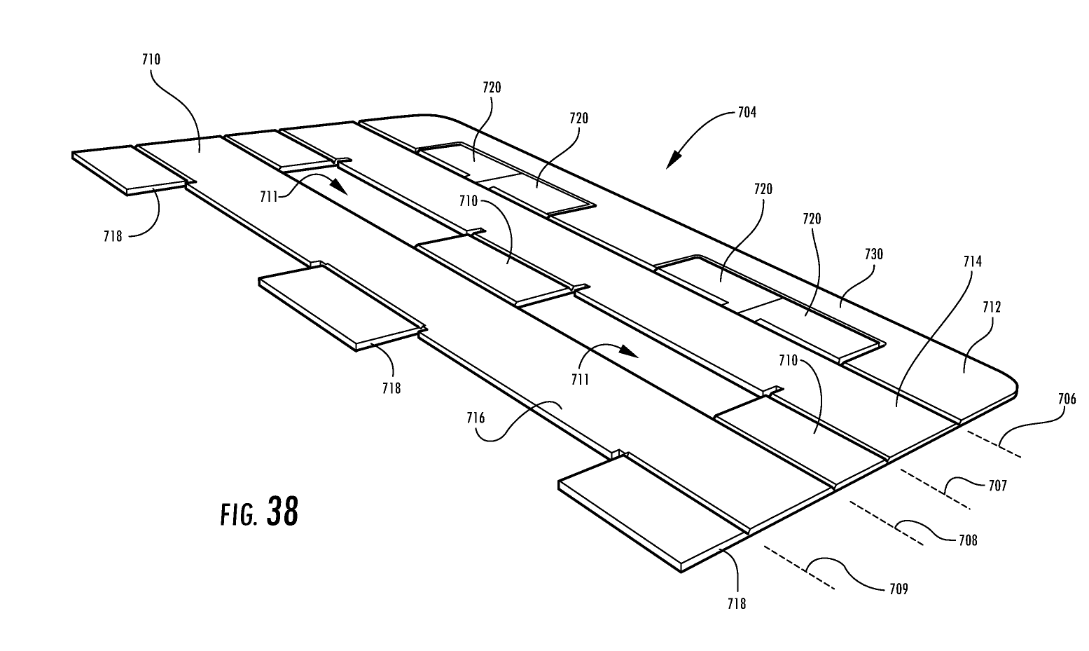

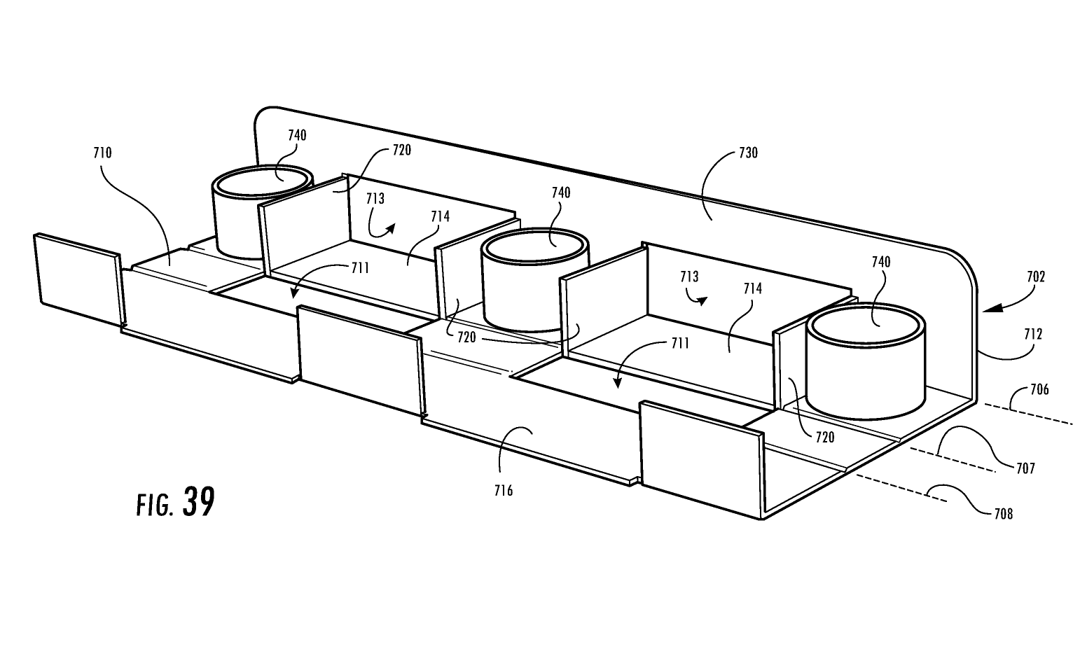

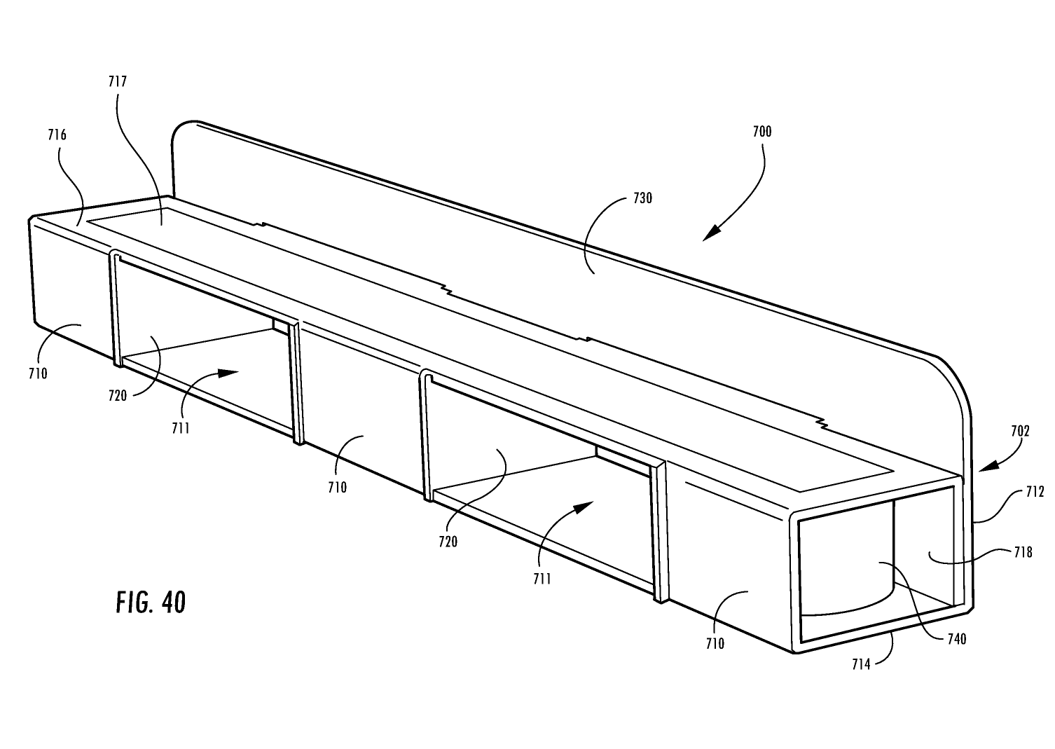

A pallet rail 700 according to at least one other embodiment of the invention is shown in respective stages of assembly in FIGS. 38-39, and is shown assembled in FIG. 40. Two or more of the assembled pallet rails 700 are usable in spaced-apart relation to support opposing ends of a rigid load and to form a pallet with the load. The assembled pallet rail 700 includes an elongate support box 702 and a plurality of separately-formed reinforcing tubes 740 as shown in FIG. 39.

To form the support box 702, a paper blank 704 is folded along three parallel fold lines 706, 707 and 708 as shown in FIGS. 38-39 to define walls of the support box 702. The support box 702 is shown partially assembled in FIG. 39 with the reinforcing tubes 740 positioned therein. The support box 702 as shown in FIG. 40 has an inner wall 710 and an outer wall 712 laterally spaced-apart from the inner wall 710, a bottom wall 714, and a vertically spaced-apart upper support wall 716 for supporting a rigid load.

Reinforcing tubes 740 are positioned within the support box 702 in spaced-apart relation along the length of the support box 702 between the bottom wall 714 and upper support wall 716 to reinforce the support box 702 and to define the distance of the upper support wall 716 above the bottom wall 714. This construction enables the pallet rail 700 to withstand heavier loads.

At least two openings 711 in the inner wall 710 and at least two openings 713 in the outer wall 712 are aligned for receiving the forks of a forklift so that a palletized load can be lifted and moved by the forklift. In the illustrated embodiment, the pallet rail 700 includes longitudinally spaced apart lateral walls 720 extending between the openings 713 in the outer wall 712 and the openings 711 in the inner wall 710 for facing the forks of the forklift.

Advantageously, as shown in FIG. 40 the pallet rail 700 includes an end wall 730 adjacent the outer wall 712 and projecting upwardly from the outer wall 712 for engaging one end of a rigid load. This feature advantageously facilitates aligning pallet rails 700 along the sides of a load. In the illustrated embodiment of the pallet rail 700, the end wall 730 is a portion of the paper blank 704 that extends integrally upward from the outer wall 712 without fold lines between the end wall 730 and outer wall 712. The end wall 730 guides the pallet rail 700 into alignment with a vertical side of a load as the pallet rail 700 is positioned under the load with the load to be supported by the upper support wall 716. With two pallet rails 700 positioned at opposing ends of a load, with their inner walls 710 facing inward toward the load and toward each other, and with their outer walls 712 position outward from the load, such that the two pallet rails oppose each other in mirror-image relation, the two pallet rails 700 and the load define a palletized load that can be lifted and moved using a forklift or pallet jack by passing the forks thereof through the openings 711 and 713 of the two pallet rails 700.

In the illustrated embodiment of the pallet rail 700, an adhesive strip 717 is positioned along the upper support wall 716 to adhere the pallet rail 700 to the bottom of a load to form a palletize load. The adhesive strip 717 includes a double-sided adhesive layer fixed along its bottom side to the upper support wall and releasably retaining a protective layer along its upper side. The protective layer, which may be a strip of waxed paper for example, is removed to expose the adhesive top side of the double sided adhesive layer to prepare the pallet rail 700 for attachment to a load. The palletized load may also be wrapped with a wrapping material, engaging particularly the end walls 730, to fix the pallet rails into position and to stabilize the load.

Furthermore, in the illustrated embodiment, the paper blank 702 of FIG. 38 includes flaps 718 that are folded along a fourth fold line 709 that is parallel to the three fold lines 706-708 to bring the flaps 718 into overlapping relation with the outer wall 712 as the support box 702 is assembled as shown in FIG. 40. The flaps 718 may be fixed into their illustrated overlapping relation with the outer wall 712 by an adhesive such as ethylene vinyl acetate (EVA) glue. Other adhesives and mechanical connectors such as staples can also be used. By fixing the 718 and the outer wall 712 together, the support box 702 is fixed in its assembled state as shown in FIG. 36.

The paper blank 704 can be made of corrugated paper, or other suitable material including moisture resistant paper board. It should be noted that the term “paper” as used here refers generally to all kinds of paper, including cardboard. The paper blank 704 may be die cut or otherwise prepared from a single planar sample of material or may be assembled from several strips joined, for example along the fold lines illustrated in FIG. 38. The reinforcing tubes 740 of FIG. 39 may be formed of densified paper. For example, the reinforcing tubes 740 may be formed as laminated layered rolls of paper.

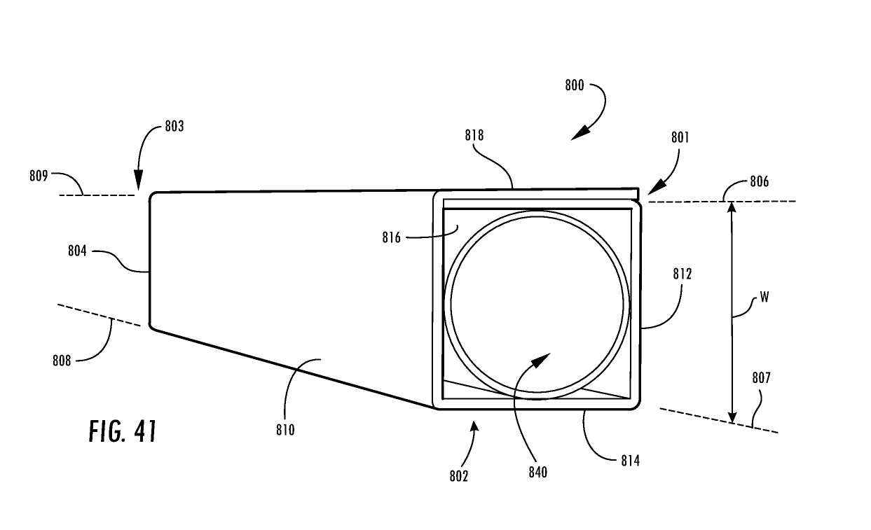

A pallet rail 800 according to at least yet another embodiment of the invention is shown in FIG. 41. Two or more of the assembled pallet rails 800 are usable in spaced-apart relation to support opposing ends of a rigid load and to form a pallet with the load. The pallet rail 800 includes an elongate support box 802 and an elongate reinforcing tube 840. The support box 802 is formed from a paper blank 804 that is folded along three parallel fold lines 806, 807 and 808 to define walls of the support box 802. The support box 802 has two laterally spaced-apart side walls 810 and 812, a bottom wall 814, a vertically spaced-apart upper support wall 816 for supporting a rigid load, and opposing longitudinal ends 801 and 803.

The reinforcing tube 840 is positioned longitudinally within the support box 802 along the length of the support box 802 between the bottom wall 814 and upper support wall 816 to reinforce the support box 802 and to define the distance of the upper support wall 816 above the bottom wall 814. This construction enables the pallet rail 800 to exhibit longitudinal rigidity and to withstand heavier loads, especially when the pallet rail 800 supports a load above an open racking system having spaced beams or when the pallet rail 800 is supported from below at its longitudinal ends 801 and 803. In the illustrated embodiment, the paper blank 804 is folded along a fourth fold line 809 that is parallel to the three fold lines 806-808 to define a second upper support wall 818 overlapping the first upper support wall 816.

The first and second upper support walls 816 and 818 may be fixed into their illustrated overlapping relation by an adhesive such as ethylene vinyl acetate (EVA) glue that is sprayed or spread onto either or both of their mutually contacting surfaces. Other adhesives and mechanical connectors such as staples can also be used. By fixing the first and second upper support walls 816 and 818 together, the support box 802 is fixed in its assembled state as shown in FIG. 41.

In at least one embodiment of a method of making the pallet rail 800, the paper blank 804 is formed into the illustrated square tube 802 having a square cross section with four sides 810, 812, 814 and 816, each having substantially the same width W as measured internally within the square tube 802. The round tube 840, which has a diameter substantially the same as the width of the four sides 810, 812, 814 and 816, is positioned into the square tube 802 to reinforce the square tube 802.

In one example of the method, the round tube 840 is positioned into the square tube 802 by inserting the round tube 840 into the longitudinal end 801 or the longitudinal end 803 of the square tube 802. In another example of the method, the first and second upper support walls 816 and 818 are hinged to open the square tube 802 along the length thereof and the round tube 840 is passed laterally into the square tube 802.

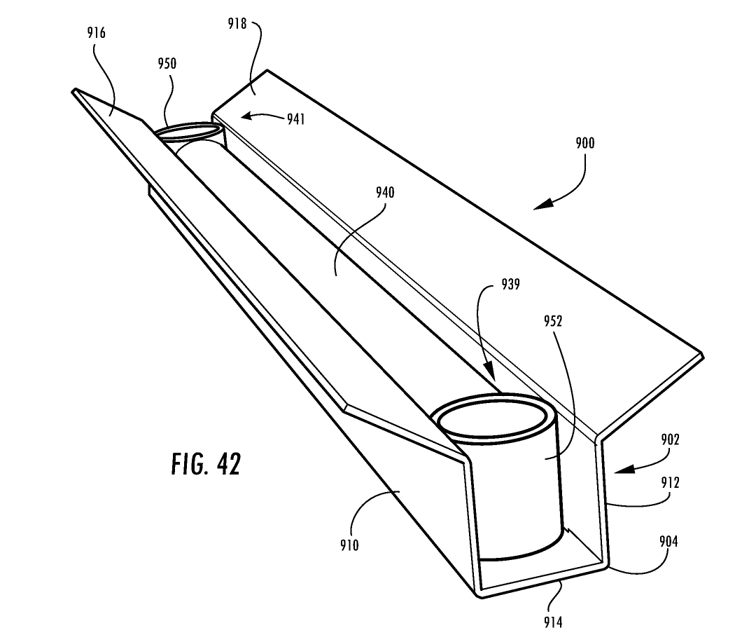

In FIG. 41, the round tube 840 has substantially the same length as the square tube 802. In FIG. 42, another embodiment of a pallet rail 900 is shown bearing some similarities to the pallet rail 800 of FIG. 41. For example, the support box 902 is formed by folding of a paper blank 904 to defined two laterally spaced-apart side walls 910 and 912, a bottom wall 914, and two upper support walls 916 and 918 that are shown in hinged open positions. However, in FIG. 42, two separately formed reinforcing tubes 950 and 952 are positioned within the support box 902 at opposing longitudinal ends 939 and 941 of the elongate reinforcing tube 940. The diameter of the reinforcing tube 940, and the lengths of the reinforcing tubes 950 and 952, define the distance between the bottom wall 914 and either of the two upper support walls 916 and 918 once the box is closed by bringing the two upper support walls 916 and 918 into overlapping positions to prepare the pallet rail 900 for use.

The paper blank 804 of FIG. 41 and the paper blank of 904 FIG. 42 can be made of corrugated paper, or other suitable material including moisture resistant paper board. It should be noted that the term “paper” as used here refers generally to all kinds of paper, including cardboard. The paper blanks 804 and 904 may be die cut or otherwise prepared from a single planar sample of material or may be assembled from several strips joined, for example along the folds illustrated in FIGS. 41 and 42. The reinforcing tube 840 of FIG. 41 and reinforcing tubes 940, 950 and 952 of FIG. 42 may be formed of densified paper. For example, the reinforcing tubes 840, 940, 950 and 952 may be formed as laminated layered rolls of paper.

The foregoing has described a pallets and methods for making the same. While specific embodiments have been described, it will be apparent to those skilled in the art that various modifications thereto can be made without departing from the spirit and scope of these descriptions. Accordingly, the foregoing descriptions of the particular embodiments and the best modes for practicing the embodiments are provided for the purpose of illustration only and not for the purpose of limitation.

What is claimed is:

1. A pallet rail, two or more of which are usable in spaced-apart relation to support respective portions of a rigid load to thereby form a pallet, comprising:
(a) an elongate support box formed from a paper blank that is folded along three parallel fold lines to define two laterally spaced-apart side walls, a bottom wall, and a vertically spaced-apart upper support wall for supporting an end portion of the rigid load; and
(b) a plurality of separately-formed reinforcing tubes positioned within the support box in spaced-apart relation along the length of the box between the bottom wall and upper support wall to reinforce the box and define the distance of the upper support wall above the bottom wall.

2. A pallet rail according to claim 1, wherein the paper blank is folded along a fourth fold line that is parallel to the three parallel fold lines to define a second bottom wall overlapping the bottom wall.

3. A pallet rail according to claim 1, wherein the upper support wall has two longitudinal ends each having a central alignment notch for aligning the pallet rail under corresponding alignment notches of the rigid load.

4. A pallet rail according to claim 1, wherein each of the two opposing longitudinal ends of the support box has at least one notch formed for receiving and holding a wrapping material for wrapping the pallet rail and rigid load.

5. A pallet rail according to claim 1, wherein the paper blank comprises corrugated paper.

6. A pallet rail according to claim 1, wherein the two side walls have arcuate corners adjacent the bottom wall to define two opposing longitudinal ends of the support box having curved lower profiles.

7. A pallet rail, a pair of which are usable in facing, spaced-apart relation to support first and second opposing ends of a rigid load to thereby form a pallet, and comprising:
(a) an elongate support box formed from a paper blank that is folded along three parallel fold lines to define an inner wall, a laterally spaced-apart outer wall, a bottom wall and a vertically spaced-apart upper support wall for supporting one end of the rigid load;
(b) an adjacent end wall projecting upwardly from the outer wall for engaging one end of the rigid load;
(c) a plurality of separately-formed reinforcing tubes positioned within the support box in spaced-apart relation along the length of the box between the bottom wall and upper support wall to reinforce the box and define the distance of the upper support wall above the bottom wall; and
(d) at least two openings in the inner wall and at least two openings in the outer wall aligned with the at least two openings in the inner wall for receiving the forks of a forklift used to move the pallet.

8. A pallet rail according to claim 7, further comprising an adhesive strip positioned along the upper support wall for adhering the pallet rail to the rigid load.

9. A pallet rail according to claim 7, further comprising longitudinally spaced-apart lateral walls extending between the openings in the inner wall and the openings in the outer wall for facing the forks of the forklift used to move the pallet.

10. A pallet rail according to claim 7, wherein the paper blank comprises corrugated paper.

11. A pallet rail according to claim 7, wherein the reinforcing tubes comprise densified paper.

12. A pallet rail, two or more of which are usable in spaced-apart relation to support respective portions of a rigid load to thereby form a pallet, comprising:
(a) an elongate support box formed from a paper blank that is folded along three parallel fold lines to define two laterally spaced-apart side walls, a bottom wall, and a vertically spaced-apart upper support wall for supporting a portion of the rigid load; and
(b) at least one elongate reinforcing tube positioned longitudinally within the support box between the bottom wall and upper support wall to reinforce the box, the tube having a diameter that defines the distance of the upper support wall above the bottom wall.

13. A pallet rail according to claim 12, further comprising two separately-formed reinforcing tubes positioned within the support box at opposing longitudinal ends of the elongate reinforcing tube and between the bottom wall and upper support wall to reinforce the box and define the distance of the upper support wall above the bottom wall.

14. A pallet rail according to claim 12, wherein the paper blank is folded along a fourth fold line that is parallel to the three parallel fold lines to define a second upper support wall overlapping the upper support wall.

15. A method of making a pallet rail, two or more of which are usable in spaced-apart relation to support respective portions of a rigid load to thereby form a pallet, comprising:
(a) forming a blank into a square tube having a square cross section with four sides each having substantially the same width within the square tube; and
(b) positioning a round tube having a diameter substantially the same as the width of the four sides into the square tube to reinforce the square tube.

16. A method according to claim 15, wherein positioning the round tube into the square tube comprises inserting the round tube into a longitudinal end of the square tube.

17. A method according to claim 15, wherein positioning the round tube into the square tube comprises hinging at least one of the four sides to open the square tube and passing the round tube laterally into the open square tube.

18. A method according to claim 15, wherein the round tube has substantially the same length as the square tube.

19. A method according to claim 15, wherein the blank comprises corrugated paper.

20. A method according to claim 15, wherein the round tube comprises densified paper.
